(19) United States
(12) Patent Application Publication
(10) Pub. No.: US 2025/0270131 A1
(43) Pub. Date: Aug. 28, 2025

(54) PHOSPHATE GLASSES WITH HIGH REFRACTIVE INDEX, LOW DENSITY AND REDUCED DISPERSION

(71) Applicant: CORNING INCORPORATED, CORNING, NY (US)

(72) Inventors: Bruce Gardiner Aitken, Corning, NY (US); Adam James Ellison, Corning, NY (US); Marc-Antoine Fortin, Corning, NY (US)

(21) Appl. No.: 19/045,794

(22) Filed: Feb. 5, 2025

Related U.S. Application Data
(60) Provisional application No. 63/558,240, filed on Feb. 27, 2024.
(60) Provisional application No. 63/562,902, filed on Mar. 8, 2024.

(51) Int. Cl. C03C 3/21

(52) U.S. Cl. CPC C03C 3/21

(57) ABSTRACT

Glass compositions include one or more of phosphorus oxide (P₂O₅), niobia (Nb₂O₅), titania (TiO₂), potassium oxide (K₂O) and lithium oxide (Li₂O) as essential components and may optionally include barium oxide (BaO), zinc oxide (ZnO), V₂O₅ (vanadia), FeO (iron oxide) and other components.

This Application claims the benefit of priority to U.S. Provisional Patent Application Ser. No. 63/558,240 filed on Feb. 27, 2024 and U.S. Provisional Patent Application Ser. No. 63/562,902 filed on Mar. 8, 2024 the contents of which are relied upon and incorporated herein by reference in their entirety.

### FIELD

The present disclosure generally relates to phosphate glasses having a high refractive index and low density.

### BACKGROUND

Glass is used in a variety of optical devices, examples of which include augmented reality devices, virtual reality devices, mixed reality devices, eye wear, etc. Desirable properties for this type of glass often include a high refractive index and a low density. Additional desirable properties may include high transmission in the visible and near-ultraviolet (near-UV) range of the electromagnetic spectrum and/or low optical dispersion. It can be challenging to find glasses having the desired combination of these properties and which can be formed from compositions having good glass-forming ability. For example, generally speaking, as the refractive index of a glass increases, the density also tends to increase. Species such as TiO₂ and Nb₂O₅ are often added to increase the refractive index of a glass without increasing the density of the glass. However, these materials often absorb blue and UV light, which can undesirably decrease the transmittance of light in this region of the spectrum by the glass. Often, attempts to increase the refractive index of a glass while maintaining a low density, and without decreasing transmittance in the blue and UV region of the spectrum, can result in a decrease in the glass-forming ability of the material. For example, crystallization and/or liquid-liquid phase separation can occur during cooling of the glass melt at cooling rates that are generally acceptable in the industry. Typically, the decrease in glass-forming ability appears as the amount of certain species, such as ZrO₂, Y₂O₃, Sc₂O₃, BaO, etc. increases.

Low density, high refractive index glasses often belong to one of two types of chemical systems, based on the glass formers used: (a) silicoborate or borosilicate glasses in which SiO₂ and/or B₂O₃ are used as the main glass formers and (b) phosphate glasses in which P₂O₅ is used as a main glass former. Glasses which rely on other oxides as main glass formers, such as GeO₂, TeO₂, Bi₂O₃, and V₂O₅, can be challenging to use due to cost, glass-forming ability, optical properties, and/or production requirements.

Phosphate glasses can be characterized by a high refractive index and low density, however, phosphate glasses can be challenging to produce due to volatilization of P₂O₅ from the melts and/or risks of platinum incompatibility. In addition, phosphate glasses are often highly colored and may require an extra bleaching step to provide a glass having the desired transmittance characteristic. Furthermore, phosphate glasses exhibiting a high refractive index also tend to have an increase in optical dispersion, which may be usable for some applications.

In view of these considerations, there is a need for phosphate glasses having a high refractive index and low density, optionally in combination with a high transmittance in the visible and near UV-range, and/or which are made from compositions that provide good glass-forming ability.

### SUMMARY

According to an embodiment of the present disclosure, a glass comprises a plurality of components, the glass having a composition of the components comprising greater than or equal to 25.5 mol. % P₂O₅, greater than or equal to 20.0 mol. % Nb₂O₅, greater than or equal to 0.5 mol. % and less than or equal to 40.0 mol. % TiO₂, greater than or equal to 0.1 mol. % and less than or equal to 8.0 mol. % Li₂O, a sum of Na₂O+K₂O greater than or equal to 1.0 mol. % and less than or equal to 30.0 mol. %, a sum of FeO+Fe₂O₃ greater than or equal to 0.000 mol. % and less than or equal to 0.020 mol. % and may optionally contain one or more components selected from Al₂O₃, B₂O₃, BaO, Bi₂O₃, CaO, CdO, Cs₂O, GeO₂, La₂O₃, MgO, MoO₃, PbO, SiO₂, SrO, Ta₂O₅, TeO₂, WO₃, ZrO₂, Ga₂O₃ and ZnO, wherein the composition of the components is substantially free of V₂O₅, and wherein the composition of the components satisfies the conditions: P₂O₅/(TiO₂+Nb₂O₅) [mol. %]≥0.30 and K₂O−Na₂O [mol. %]≥0.000, and the glass satisfies the conditions: Pₙ>1.9000 and P_{d}<3.80, where Pₙ is a refractive index parameter, calculated from the glass composition in terms of mol. % of the components according to the Formula (I):

$${P}_{n} = 1.82063 - 0.0023121 * {AlO}_{3} - 0.003381 * {B}_{2} {O}_{3} - 0.00024425 * BaO + 0.0088252 * {Bi}_{2} {O}_{3} - 0.00051393 * CaO + 0.00083458 * CdO - 0.0021789 * {Cs}_{2} O - 0.0015444 * {GeO}_{2} - 0.0037344 * {K}_{2} O + 0.0022272 * {La}_{2} {O}_{3} - 0.0016171 * {Li}_{2} O - 0.0015687 * MgO + 0.0026917 * {MoO}_{3} - 0.0023954 * {Na}_{2} O + 0.007544 * {Nb}_{2} {O}_{5} - 0.0049543 * {P}_{2} {O}_{5} + 0.0033051 * PbO - 0.0029543 * {SiO}_{2} - 0.00038966 * SrO + 0.0069184 * {Ta}_{2} {O}_{5} + 0.0025768 * {TeO}_{2} + 0.0037599 * {TiO}_{2} + 0.0041441 * {V}_{2} {O}_{5} + 0.0032619 * {WO}_{3} + 0.0024821 * {ZrO}_{2} , \qquad ( I )$$

P_{d} is a density parameter, calculated from the glass composition in terms of mol. % of the components according to the Formula (II):

$${P}_{d} = 3.98457 - 0.015773 * {Al}_{2} {O}_{3} - 0.014501 * {B}_{2} {O}_{3} + 0.019328 * BaO + 0.060758 * {Bi}_{2} {O}_{3} - 0.0012685 * CaO + 0.023111 * CdO + 0.0053184 * {Cs}_{2} O + 0.011488 * {Ga}_{2} {O}_{3} - 0.0015416 * {GeO}_{2} - 0.013342 * {K}_{2} O + 0.058319 * {La}_{2} {O}_{3} - 0.007918 * {Li}_{2} O - 0.0024123 * MgO - 0.0024413 * {MoO}_{3} - 0.0082226 * {Na}_{2} O + 0.0084961 * {Nb}_{2} {O}_{5} - 0.020501 * {P}_{2} {O}_{5} + 0.038898 * PbO - 0.01272 * {SiO}_{2} + 0.013948 * SrO + 0.047924 * {Ta}_{2} {O}_{5} + 0.011248 * {YeO}_{2} - 0.0092491 * {V}_{2} {O}_{5} + 0.028913 * {WO}_{3} + 0.0074702 * ZnO + 0.0096721 * {ZrO}_{2} , \qquad ( II )$$

where chemical formulas mean the content of corresponding components in the glass and an asterisk (*) means multiplication.

These and other aspects, objects, and features of the present disclosure will be understood and appreciated by those skilled in the art upon studying the following specification, claims, and appended drawings.

### BRIEF DESCRIPTION OF THE DRAWINGS

FIG. 1 is a plot illustrating the relationship between the refractive index na and the refractive index parameter Pₙ calculated by formula (I) for some Comparative Glasses and some Exemplary Glasses according to an embodiment of the present disclosure.

FIG. 2 is a plot illustrating the relationship between the density d_{RT} and the density parameter P_{d} calculated by formula (II) for some Comparative Glasses and some Exemplary Glasses according to an embodiment of the present disclosure.

FIG. 3 is a plot illustrating the relationship between the Abbe number ν_{d} and the dispersion parameter P_{ν} calculated by formula (III) for some Comparative Glasses and some Exemplary Glasses according to an embodiment of the present disclosure.

FIG. 4 is a plot illustrating the relationship between the refraction (n_{d}−1)/d_{RT} and the refraction parameter P_{ref} calculated by formula (IV) for some Comparative Glasses and some Exemplary Glasses according to an embodiment of the present disclosure.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that an order be inferred, in any respect. This holds for any possible non-express basis for interpretation, including, without limitation, matters of logic with respect to arrangement of steps or operational flow; plain meaning derived from grammatical organization or punctuation; the number or type of embodiments described in the specification.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those skilled in the art. When the term “about” is used in describing a value or an end-point of a range, the disclosure should be understood to include the specific value or end-point referred to. It will be further understood that the end-points of each of the ranges are significant both in relation to the other end-point, and independently of the other end-point.

The term “component” refers to a material or compound included in a batch composition from which a glass is formed. Components include oxides, including but not limited to those expressed in Formulas (I)-(IV), and the claims. Representative components include B₂O₃, P₂O₅, Al₂O₃, CuO, Cu₂O, RO, R₂O, SnO₂, MnO₂, REₘOₙ, SiO₂, Ta₂O₅, ZnO, WO₃, Nb₂O₅, TiO₂, ZrO₂, Bi₂O₃, TeO₂, etc. Other representative components include halogens (e.g. F, Br, Cl). Whenever a component is included as a term in a mathematical expression or formula, it is understood that the component refers to the amount of the component in units of mol. % in the batch composition of the glass. For example, the expression “B₂O₃+P₂O₅” refers to the sum of the amount of B₂O₃ in units of mol. % and the amount of P₂O₅ in units of mol. % in the batch composition of the glass. A mathematical expression or formula is any expression or formula that includes a mathematical operator such as “+”, “−”, “*”, “/”, “min”, or “max”.

Unless otherwise specified, the amount or content of a component in a glass composition is expressed herein in units of mol. % (mole percent).

The term “formed from” can mean one or more of comprises, consists essentially of, or consists of. For example, a component that is formed from a particular material can comprise the particular material, consist essentially of the particular material, or consist of the particular material.

The terms “free” and “substantially free” are used interchangeably herein to refer to an amount and/or an absence of a particular component in a glass composition that is not intentionally added to the glass composition. It is understood that the glass composition may contain traces of a particular constituent component as a contaminant or a tramp in an amount of less than 0.10 mol. %.

As used herein, the term “tramp”, when used to describe a particular constituent component in a glass composition, refers to a constituent component that is not intentionally added to the glass composition and is present in an amount of less than 0.10 mol. %. Tramp components may be unintentionally added to the glass composition as an impurity in another constituent component and/or through migration of the tramp component into the composition during processing of the glass composition.

Unless otherwise specified, the term “glass” is used to refer to a glass made from a glass composition disclosed herein.

The symbol “*” means multiplication when used in any formula herein.

Temperature is expressed herein in units of ° C. (degrees Celsius).

Density is expressed herein in units of g/cm³.

The term “glass former” is used herein to refer to a component that, being solely present in the glass composition (i.e., without other components, except for tramps), is able to form a glass when cooling the melt at a rate of not greater than about 300° C./min.

The term “modifier”, as used herein, refers to the oxides of monovalent or divalent metals, i.e., R₂O or RO, where “R” stands for a cation. Modifiers can be added to a glass composition to change the atomic structure of the melt and the resulting glass. In some embodiments, the modifier may change the coordination numbers of cations present in the glass formers (e.g., boron in B₂O₃), which may result in forming a more polymerized atomic network and, as a result, may provide better glass formation.

As used herein, the term “RO” refers to a total content of divalent metal oxides, the term “R₂O” refers to a total content of monovalent metal oxides, and the term “Alk₂O” refers to a total content of alkali metal oxides. The term R₂O encompasses alkali metal oxides (Alk₂O), in addition to other monovalent metal oxides, such as Ag₂O, Tl₂O, and Hg₂O, for example.

The measured density values for the glasses reported herein were measured at room temperature in units of g/cm³ by Archimedes method in water with an error of 0.001 g/cm³. As used herein, density measurements at room temperature (specified as d_{RT}) are indicated as being measured at 20° C.

As used herein, good glass forming ability refers to a resistance of the melt to devitrification as the material cools. Glass forming ability can be measured by determining the critical cooling rate of the melt. The terms “critical cooling rate” or “v_{cr}” are used herein to refer to the minimum cooling rate at which a melt of a given composition forms a glass free of crystals visible under an optical microscope under magnification of 500×. The critical cooling rate can be used to measure the glass-forming ability of a composition, i.e., the ability of the melt of a given glass composition to form glass when cooling. Generally speaking, the lower the critical cooling rate, the better the glass-forming ability.

The term “liquidus temperature” (T_{liq}) is used herein to refer to a temperature above which the glass composition is completely liquid with no crystallization of constituent components of the glass. The liquidus temperature values reported herein were obtained by measuring samples using either DSC or by isothermal hold of samples wrapped in platinum foil. For samples measured using DSC, powdered samples were heated at 10 K/min to 1250° C. The end of the endothermal event corresponding to the melting of crystals was taken as the liquidus temperature. For the second technique (isotactic hold), a glass block (about 1 cm³) was wrapped in platinum foil, to avoid volatilization, and placed in a furnace at a given temperature for 17 hours. The glass block was then observed under an optical microscope to check for crystals.

The refractive index values reported herein were measured at room temperature, unless otherwise specified. The refractive index values for a glass sample were measured using a Metricon Model 2010 prism coupler refractometer with an error of about ±0.0002. Using the Metricon, the refractive index of a glass sample was measured at two or more wavelengths of about 406 nm, 473 nm, 532 nm, 633 nm, 828 nm, and 1064 nm. The measured dependence characterizes the dispersion and was then fitted with a Cauchy's law equation or Sellmeier equation to allow for calculation of the refractive index of the sample at a given wavelength of interest between the measured wavelengths. The term “refractive index nd” is used herein to refer to a refractive index calculated as described above at a wavelength of 587.56 nm, which corresponds to the helium d-line wavelength. The term “refractive index n_{C}” is used herein to refer to a refractive index calculated as described above at a wavelength of 656.3 nm. The term “refractive index nr” is used herein to refer to a refractive index calculated as described above at a wavelength of 486.1 nm. The term “refractive index ng” is used herein to refer to a refractive index calculated as described above at a wavelength of 435.8 nm.

As used herein, the terms “high refractive index” or “high index” refer to a refractive index value of a glass that is greater than or equal to 1.8000, unless otherwise indicated. In embodiments the terms “high refractive index” or “high index” refer to a refractive index value of a glass that is greater than or equal to 1.8500, greater than or equal to 1.9000, or greater than or equal to 1.9500, or greater than or equal to 2.0000.

The terms “dispersion” and “optical dispersion” are used interchangeably to refer to a difference or ratio of the refractive indices of a glass sample at predetermined wavelengths. One numerical measure of optical dispersion reported herein is the Abbe number, which can be calculated by the formula: νₓ=(nₓ−1)/(n_{F}−n_{C}), where “x” in the present disclosure stands for one of the commonly used wavelengths (for example, 587.56 nm [d-line] for ν_{d} or 589.3 nm [D-line] for ν_{D}, nₓ is the refractive index at this wavelength (for example, n_{d} for ν_{d} and n_{D} for ν_{D}), and n_{F} and n_{C} are refractive indices at the wavelengths 486.1 nm (F-line) and 656.3 nm (C-line), respectively. The numerical values of ν_{d} and ν_{D} differ very slightly, mostly within ±0.1% to ±0.2%. As reported herein, the dispersion of a glass sample is represented by the Abbe number (ν_{d}), which characterizes the relationship between the refractive indices of the sample at three different wavelengths according to the following formula: ν_{d}=(n_{d}−1)/(n_{F}−n_{C}), where n_{d} is the calculated refractive index at 587.56 nm (d-line), n_{F} is the calculated refractive index at 486.1 nm, and n_{C} is the calculated refractive index at 656.3 nm. A higher Abbe number corresponds to a lower optical dispersion.

The glass transition temperature (T_{g}) is measured by differential scanning calorimeter (DSC) at the heating rate of 10 K/min after cooling in air.

Glass composition may include phosphorus oxide (P₂O₅). The glass compositions in the embodiments described herein comprise phosphorus oxide (P₂O₅) as a main glass-former. Greater amounts of P₂O₅ increase the melt viscosity at a given temperature, which inhibits crystallization from the melt when cooling and, therefore, improves the glass-forming ability of the melt (i.e. lowers the critical cooling rate of the melt). However, P₂O₅ significantly decreases the refractive index, which makes it more difficult to reach high index. Accordingly, the content of P₂O₅ in high-index glasses is limited. In embodiments, the glass composition may contain phosphorus oxide (P₂O₅) in an amount from greater than or equal to 25.0 mol. % to less than or equal to 42.0 mol. % and all ranges and sub-ranges between the foregoing values. In some embodiments, the glass composition may contain P₂O₅ in an amount greater than or equal to 25.0 mol. %, or greater than or equal to 25.5 mol. %, or greater than or equal to 26.2 mol. %, or greater than or equal to 26.5 mol. %, or greater than or equal to 27.5 mol. %, or greater than or equal to 28.0 mol. %, or greater than or equal to 30.0 mol. %, or greater than or equal to 35.0 mol. %, or greater than or equal to 36.0 mol. %, or greater than or equal to 38.0 mol. %, or greater than or equal to 40.0 mol. %. In some other embodiments, the glass composition may contain P₂O₅ in an amount less than or equal to 42.0 mol. %, or less than or equal to 40.0 mol. %, or less than or equal to 38.0 mol. %, or less than or equal to 36.0 mol. %, or less than or equal to 35.0 mol. %, or less than or equal to 32.0 mol. %, or less than or equal to 30.0 mol. %, or less than or equal to 29.0 mol. %, or less than or equal to 28.4 mol. %. In some more embodiments, the glass composition may contain P₂O₅ in an amount greater than or equal to 26.0 mol. % and less than or equal to 32.0 mol. %, or greater than or equal to 25.0 mol. % and less than or equal to 29.0 mol. %, or greater than or equal to 25.5 mol. % and less than or equal to 29.0 mol. %, or greater than or equal to 26.2 mol. % and less than or equal to 29.0 mol. %, or greater than or equal to 26.5 mol. % and less than or equal to 28.4 mol. %, or greater than or equal to 27.95 mol. % and less than or equal to 28.96 mol. %, or greater than or equal to 25.0 mol. % and less than or equal to 42.0 mol. %, or greater than or equal to 25.5 mol. % and less than or equal to 28.4 mol. %, or greater than or equal to 26.2 mol. % and less than or equal to 28.4 mol. %, or greater than or equal to 27.5 mol. % and less than or equal to 28.4 mol. %, or greater than or equal to 30.0 mol. % and less than or equal to 32.0 mol. %.

Glass composition may include zinc oxide (ZnO). Zinc oxide provides a comparably good refractive index to density ratio and may sometimes increase the solubility of titania, which indirectly increases the refractive index of glasses. However, it was found that in some embodiments, at high concentrations of ZnO, the glass forming ability of the melt decreases and the melt may tend to crystallize during cooling. That is why the amount of ZnO in the glasses of the present disclosure is limited, or glass compositions may be free of ZnO. In embodiments, the glass composition may contain zinc oxide (ZnO) in an amount from greater than or equal to 0.0 mol. % to less than or equal to 5.0 mol. % and all ranges and sub-ranges between the foregoing values. In some other embodiments, the glass composition may contain ZnO in an amount less than or equal to 5.0 mol. %, or less than or equal to 2.5 mol. %, or less than or equal to 2.0 mol. %, or less than or equal to 1.8 mol. %, or less than or equal to 1.6 mol. %, or less than or equal to 0.1 mol. %. In some more embodiments, the glass composition may contain ZnO in an amount greater than or equal to 0.0 mol. % and less than or equal to 2.0 mol. %, or greater than or equal to 0.0 mol. % and less than or equal to 1.8 mol. %, or greater than or equal to 0.0 mol. % and less than or equal to 1.6 mol. %, or greater than or equal to 0.0 mol. % and less than or equal to 0.1 mol. %, or greater than or equal to 0.0 mol. % and less than or equal to 5.0 mol. %.

Glass composition may include barium oxide (BaO). Barium oxide may increase the solubility of high index components, such as TiO₂ and Nb₂O₅, more than other divalent metal oxides, which may indirectly lead to a further increase in the refractive index at comparably low density. However, barium is a heavy element and, being added in a high amount, may increase the density of glass. Also, at high concentration, it may cause crystallization of such minerals as barium titanate (BaTiO₃), barium niobate (BaNb₂O₆), barium orthophosphate (Ba₃P₂O₈) and others, which may cause crystallization of a melt when cooling. Accordingly, the amount of BaO in glasses of the present disclosure is limited. In embodiments, the glass composition may contain barium oxide (BaO) in an amount from greater than or equal to 0.0 mol. % to less than or equal to 10.0 mol. % and all ranges and sub-ranges between the foregoing values. In some embodiments, the glass composition may contain BaO in an amount greater than or equal to 0.0 mol. %, or greater than or equal to 1.5 mol. %, or greater than or equal to 5.0 mol. %, or greater than or equal to 6.0 mol. %. In some other embodiments, the glass composition may contain BaO in an amount less than or equal to 10.0 mol. %, or less than or equal to 8.5 mol. %, or less than or equal to 8.0 mol. %, or less than or equal to 7.75 mol. %, or less than or equal to 5.0 mol. %. In some more embodiments, the glass composition may contain BaO in an amount greater than or equal to 0.0 mol. % and less than or equal to 11.0 mol. %, or greater than or equal to 0.0 mol. % and less than or equal to 10.0 mol. %, or greater than or equal to 0.0 mol. % and less than or equal to 8.5 mol. %, or greater than or equal to 1.5 mol. % and less than or equal to 7.75 mol. %, or greater than or equal to 5.99 mol. % and less than or equal to 8.49 mol. %, or greater than or equal to 0.0 mol. % and less than or equal to 5.0 mol. %, or greater than or equal to 1.5 mol. % and less than or equal to 10.0 mol. %, or greater than or equal to 1.5 mol. % and less than or equal to 5.0 mol. %, or greater than or equal to 5.0 mol. % and less than or equal to 10.0 mol. %, or greater than or equal to 5.0 mol. % and less than or equal to 7.75 mol. %.

The glass may include calcium oxide (CaO) and/or strontium oxide (SrO) independently or in combination, or in combination with BaO. The glass composition may include a sum of CaO+SrO+BaO greater than or equal to 0.0 mol. % to less than or equal to 15.0 mol. % and all ranges and sub-ranges between the foregoing values. In embodiments, the glass composition may contain a sum of CaO+SrO+BaO greater than or equal to 0.0 mol. %, or greater than or equal to 1.5 mol. %, or greater than or equal to 3.0 mol. %, or greater than or equal to 4.5 mol. %, or greater than or equal to 6.0 mol. %, or greater than or equal to 7.5 mol. %. In some other embodiments, the glass composition may contain a sum of CaO+SrO+BaO less than or equal to 15.0 mol. %, or less than or equal to 12.0 mol. %, or less than or equal to 10.5 mol. %, or less than or equal to 9.0 mol. %, or less than or equal to 7.5 mol. %. In some more embodiments, the glass composition may contain a sum of CaO+SrO+BaO greater than or equal to 0.0 mol. % and less than or equal to 15.0 mol. %, or greater than or equal to 1.5 mol. % and less than or equal to 12.0 mol. %, or greater than or equal to 3.0 mol. % and less than or equal to 10.5 mol. %, or greater than or equal to 4.5 mol. % and less than or equal to 9.0 mol. %, or greater than or equal to 6.0 mol. % and less than or equal to 9.0 mol. %.

Glass composition may include vanadia (V₂O₅). Vanadia provides the highest ratio of the refractive index to density among all oxides. However, vanadia may cause undesirable dark or even black coloring and may also raise environmental concerns. For these reasons, the content of vanadia in the glasses of the present disclosure is limited, or glass compositions may be free of V₂O₅. In embodiments, the glass composition may contain vanadia (V₂O₅) in an amount from greater than or equal to 0.0 mol. % to less than or equal to 0.05 mol. % and all ranges and sub-ranges between the foregoing values. In some other embodiments, the glass composition may contain V₂O₅ in an amount less than or equal to 0.05 mol. % or less than or equal to 0.025 mol. %. In some more embodiments, the glass composition may contain V₂O₅ in an amount greater than or equal to 0.0 mol. % and less than or equal to 0.05 mol. %, or greater than or equal to 0.0 mol. % and less than or equal to 0.025 mol. %.

Glass composition may include lithium oxide (Li₂O). Lithium oxide provides the highest ratio of the refractive index to density of glasses among the known monovalent metal oxides. Also, in some embodiments, Li₂O may help to increase the solubility of Nb₂O₅ and TiO₂, which additionally increases the refractive index at comparably low density. In addition, lithium oxide may hasten the process of bleaching the glasses. However, it was empirically found that in some embodiments, addition of Li₂O, even in small concentrations, may decrease the glass-forming ability of glasses by causing crystallization or liquid-liquid phase separation of glass-forming melts when cooling. Therefore, the amount of Li₂O in glasses of the present disclosure is limited. However, the mentioned undesirable effects of Li₂O are difficult to predict; for this reason, the exact boundary of Li₂O in the embodiments may be very different. In particular, in some embodiments, the glasses may be substantially free of Li₂O. In embodiments, the glass composition may contain lithium oxide (Li₂O) in an amount from greater than or equal to 0.1 mol. % to less than or equal to 8.0 mol. % and all ranges and sub-ranges between the foregoing values. In some embodiments, the glass composition may contain Li₂O in an amount greater than or equal to 0.1 mol. %, or greater than or equal to 1.0 mol. %, or greater than or equal to 1.1 mol. %, or greater than or equal to 1.25 mol. %, or greater than or equal to 1.5 mol. %, or greater than or equal to 2.0 mol. %, or greater than or equal to 5.0 mol. %, or greater than or equal to 6.0 mol. %, or greater than or equal to 7.0 mol. %. In some other embodiments, the glass composition may contain Li₂O in an amount less than or equal to 8.0 mol. %, or less than or equal to 7.0 mol. %, or less than or equal to 6.0 mol. %, or less than or equal to 5.0 mol. %, or less than or equal to 3.0 mol. %, or less than or equal to 2.5 mol. %, or less than or equal to 2.3 mol. %, or less than or equal to 2.15 mol. %, or less than or equal to 2.0 mol. %. In some more embodiments, the glass composition may contain Li₂O in an amount greater than or equal to 0.1 mol. % and less than or equal to 8.0 mol. %, or greater than or equal to 1.0 mol. % and less than or equal to 2.5 mol. %, or greater than or equal to 1.1 mol. % and less than or equal to 2.3 mol. %, or greater than or equal to 1.25 mol. % and less than or equal to 2.15 mol. %, or greater than or equal to 1.5 mol. % and less than or equal to 3.0 mol. %, or greater than or equal to 0.1 mol. % and less than or equal to 2.0 mol. %, or greater than or equal to 1.0 mol. % and less than or equal to 8.0 mol. %, or greater than or equal to 1.0 mol. % and less than or equal to 5.0 mol. %, or greater than or equal to 1.0 mol. % and less than or equal to 2.0 mol. %, or greater than or equal to 1.1 mol. % and less than or equal to 8.0 mol. %, or greater than or equal to 1.1 mol. % and less than or equal to 2.0 mol. %, or greater than or equal to 1.5 mol. % and less than or equal to 8.0 mol. %.

Glass composition may include potassium oxide (K₂O). Potassium oxide may increase the solubility of high index components, such as TiO₂ and Nb₂O₅, more than other monovalent and divalent metal oxides, which may indirectly increase the refractive index at comparably low density. However, potassium oxide itself provides the lowest refractive index among the mentioned oxides. Therefore, at high concentrations of K₂O, it may be difficult to reach high refractive index. Accordingly, the amount of K₂O in glasses of the present disclosure is limited, or glasses may be substantially free of K₂O. In embodiments, the glass composition may contain potassium oxide (K₂O) in an amount from greater than or equal to 0.0 mol. % to less than or equal to 30.0 mol. % and all ranges and sub-ranges between the foregoing values. In some embodiments, the glass composition may contain K₂O in an amount greater than or equal to 0.0 mol. %, or greater than or equal to 5.0 mol. %, or greater than or equal to 6.0 mol. %, or greater than or equal to 6.75 mol. %, or greater than or equal to 10.0 mol. %, or greater than or equal to 20.0 mol. %, or greater than or equal to 24.0 mol. %, or greater than or equal to 26.0 mol. %, or greater than or equal to 28.0 mol. %. In some other embodiments, the glass composition may contain K₂O in an amount less than or equal to 30.0 mol. %, or less than or equal to 28.0 mol. %, or less than or equal to 26.0 mol. %, or less than or equal to 24.0 mol. %, or less than or equal to 20.0 mol. %, or less than or equal to 15.0 mol. %, or less than or equal to 14.0 mol. %, or less than or equal to 13.25 mol. %, or less than or equal to 10.0 mol. %, or less than or equal to 5.0 mol. %. In some more embodiments, the glass composition may contain K₂O in an amount greater than or equal to 2.0 mol. % and less than or equal to 15.0 mol. %, or greater than or equal to 5.0 mol. % and less than or equal to 15.0 mol. %, or greater than or equal to 6.0 mol. % and less than or equal to 14.0 mol. %, or greater than or equal to 6.75 mol. % and less than or equal to 13.25 mol. %, or greater than or equal to 0.0 mol. % and less than or equal to 30.0 mol. %, or greater than or equal to 0.0 mol. % and less than or equal to 5.0 mol. %, or greater than or equal to 5.0 mol. % and less than or equal to 10.0 mol. %, or greater than or equal to 6.0 mol. % and less than or equal to 30.0 mol. %, or greater than or equal to 6.0 mol. % and less than or equal to 10.0 mol. %, or greater than or equal to 6.75 mol. % and less than or equal to 30.0 mol. %, or greater than or equal to 6.75 mol. % and less than or equal to 10.0 mol. %, or greater than or equal to 10.0 mol. % and less than or equal to 13.25 mol. %, or greater than or equal to 20.0 mol. % and less than or equal to 24.0 mol. %.

Glass composition may include niobia (Nb₂O₅). Niobia, like titania, can be used in some aspects of the present disclosure to increase the refractive index of glass while also maintaining a low density. However, niobia can introduce a yellow coloring to the glass that cannot be bleached in the same manner as titania, which can result in a loss of transmittance, particularly in the blue and UV range. Niobia, like titania, may cause crystallization and/or phase separation of the melt. In some cases, niobia may provide the glass with a high optical dispersion, which can be significantly higher than that induced by titania and some other high index components, when added in similar concentrations. The effects of niobia can be affected by the other components of the glass, and thus it can be challenging to determine an exact limit for niobia. In some embodiments, the glasses may be substantially free of Nb₂O₅; in this case, its function is performed by other species, such as, for example, TiO₂. In embodiments, the glass composition may contain niobia (Nb₂O₅) in an amount from greater than or equal to 15.0 mol. % to less than or equal to 48.0 mol. % and all ranges and sub-ranges between the foregoing values. In some embodiments, the glass composition may contain Nb₂O₅ in an amount greater than or equal to 15.0 mol. %, or greater than or equal to 20.0 mol. %, or greater than or equal to 22.0 mol. %, or greater than or equal to 23.0 mol. %, or greater than or equal to 24.0 mol. %, or greater than or equal to 28.0 mol. %, or greater than or equal to 30.0 mol. %, or greater than or equal to 32.0 mol. %, or greater than or equal to 33.0 mol. %, or greater than or equal to 35.0 mol. %, or greater than or equal to 38.0 mol. %, or greater than or equal to 43.0 mol. %. In some other embodiments, the glass composition may contain Nb₂O₅ in an amount less than or equal to 48.0 mol. %, or less than or equal to 44.0 mol. %, or less than or equal to 43.0 mol. %, or less than or equal to 40.0 mol. %, or less than or equal to 38.0 mol. %, or less than or equal to 37.0 mol. %, or less than or equal to 36.0 mol. %, or less than or equal to 35.0 mol. %, or less than or equal to 33.0 mol. %, or less than or equal to 30.0 mol. %, or less than or equal to 20.0 mol. %. In some more embodiments, the glass composition may contain Nb₂O₅ in an amount greater than or equal to 20.0 mol. % and less than or equal to 42.0 mol. %, or greater than or equal to 20.0 mol. % and less than or equal to 35.0 mol. %, or greater than or equal to 22.0 mol. % and less than or equal to 33.0 mol. %, or greater than or equal to 23.0 mol. % and less than or equal to 30.0 mol. %, or greater than or equal to 23.97 mol. % and less than or equal to 32.97 mol. %, or greater than or equal to 28.0 mol. % and less than or equal to 35.0 mol. %, or greater than or equal to 15.0 mol. % and less than or equal to 48.0 mol. %, or greater than or equal to 15.0 mol. % and less than or equal to 20.0 mol. %, or greater than or equal to 20.0 mol. % and less than or equal to 30.0 mol. %, or greater than or equal to 23.0 mol. % and less than or equal to 48.0 mol. %, or greater than or equal to 24.0 mol. % and less than or equal to 48.0 mol. %, or greater than or equal to 24.0 mol. % and less than or equal to 30.0 mol. %.

Glass composition may include titania (TiO₂). High refractive index glasses typically include species, such as TiO₂ and Nb₂O₅, that absorb at least a portion of optical light, particularly light in the blue and near-UV regions of the electromagnetic spectrum. In embodiments of the present disclosure, the transmittance of the glass may be characterized for different wavelengths within the range of from about 300 nm to 2300 nm. High transmission in the visible and near-UV range (blue region) is particularly desirable in some applications. High transmittance in the blue can be challenging to achieve in high refractive index glasses. High level of TiO₂ and/or Nb₂O₅ that are typically used in glasses to increase refractive index tend to decrease the transmittance in the near-UV region and shift the UV cut-off to higher wavelengths. Accordingly, the amount of TiO₂ in the glass compositions of the present disclosure is limited. In embodiments, the glass composition may contain titania (TiO₂) in an amount from greater than or equal to 0.5 mol. % to less than or equal to 44.0 mol. % and all ranges and sub-ranges between the foregoing values. In some embodiments, the glass composition may contain TiO₂ in an amount greater than or equal to 0.5 mol. %, or greater than or equal to 10.0 mol. %, or greater than or equal to 13.0 mol. %, or greater than or equal to 15.0 mol. %, or greater than or equal to 17.0 mol. %, or greater than or equal to 18.0 mol. %, or greater than or equal to 20.0 mol. %, or greater than or equal to 21.0 mol. %, or greater than or equal to 22.0 mol. %, or greater than or equal to 25.0 mol. %, or greater than or equal to 29.0 mol. %, or greater than or equal to 34.0 mol. %, or greater than or equal to 39.0 mol. %. In some other embodiments, the glass composition may contain TiO₂ in an amount less than or equal to 44.0 mol. %, or less than or equal to 40.0 mol. %, or less than or equal to 39.0 mol. %, or less than or equal to 36.0 mol. %, or less than or equal to 35.0 mol. %, or less than or equal to 34.5 mol. %, or less than or equal to 34.0 mol. %, or less than or equal to 33.0 mol. %, or less than or equal to 32.0 mol. %, or less than or equal to 29.0 mol. %, or less than or equal to 25.0 mol. %, or less than or equal to 24.0 mol. %, or less than or equal to 23.5 mol. %, or less than or equal to 22.5 mol. %, or less than or equal to 20.0 mol. %, or less than or equal to 10.0 mol. %. In some more embodiments, the glass composition may contain TiO₂ in an amount greater than or equal to 0.5 mol. % and less than or equal to 40.0 mol. %, or greater than or equal to 10.0 mol. % and less than or equal to 40.0 mol. %, or greater than or equal to 13.0 mol. % and less than or equal to 38.4 mol. %, or greater than or equal to 15.0 mol. % and less than or equal to 35.0 mol. %, or greater than or equal to 18.0 mol. % and less than or equal to 23.5 mol. %, or greater than or equal to 21.5 mol. % and less than or equal to 34.5 mol. %, or greater than or equal to 21.5 mol. % and less than or equal to 33.0 mol. %, or greater than or equal to 21.96 mol. % and less than or equal to 32.96 mol. %, or greater than or equal to 0.5 mol. % and less than or equal to 44.0 mol. %, or greater than or equal to 0.5 mol. % and less than or equal to 10.0 mol. %, or greater than or equal to 10.0 mol. % and less than or equal to 20.0 mol. %, or greater than or equal to 15.0 mol. % and less than or equal to 44.0 mol. %, or greater than or equal to 15.0 mol. % and less than or equal to 20.0 mol. %, or greater than or equal to 18.0 mol. % and less than or equal to 44.0 mol. %, or greater than or equal to 18.0 mol. % and less than or equal to 20.0 mol. %, or greater than or equal to 20.0 mol. % and less than or equal to 22.5 mol. %, or greater than or equal to 21.5 mol. % and less than or equal to 44.0 mol. %, or greater than or equal to 21.5 mol. % and less than or equal to 22.5 mol. %, or greater than or equal to 22.0 mol. % and less than or equal to 22.5 mol. %.

In some embodiments, glass composition may have limitations for a sum FeO+Fe₂O₃. Iron oxides (FeO and Fe₂O₃), and especially FeO, may provide undesirable coloration to the glasses of the present disclosure, even when added in very low concentrations, such as 0.02 mol. %, 0.01 mol. %, or even 0.007 mol. %. Accordingly, the glasses of the present disclosure are substantially free of iron oxides. However, iron oxides may be presented in the glasses of the present disclosure in very small concentrations as impurities in the starting materials. In some other embodiments, the glass composition may contain a sum of FeO+Fe₂O₃ in an amount less than or equal to 0.02 mol. % or less than or equal to 0.01 mol. %. In some more embodiments, the glass composition may contain FeO+Fe₂O₃ in an amount greater than or equal to 0.0 mol. % and less than or equal to 0.02 mol. %, or greater than or equal to 0.0 mol. % and less than or equal to 0.01 mol. %.

In some embodiments, glass composition may have limitations for a sum Na₂O+K₂O. Adding the alkali metal oxides other than Li₂O, i.e., Na₂O and K₂O, is necessary to protect the glasses of the present disclosure from devitrification when cooling. This is caused by the devitrification tendency of lithium-rich glasses. Preferably, to provide better protection from devitrification, the glasses of the present disclosure contain, at least, two different alkali oxides, one of which is Li₂O and another may be Na₂O, K₂O or their combination. Accordingly, the glasses of the present disclosure include, at least, one of Na₂O and K₂O, or their combination. However, when the sum of Na₂O+K₂O is high, the glasses of the present disclosure may have a lower viscosity and, therefore, lower liquidus viscosity, which adversely decrease the durability of glasses to devitrification when cooling. Accordingly, the content of Na₂O+K₂O is preferably limited. In some embodiments, the glass composition may have a sum of Na₂O+K₂O greater than or equal to 1.0 mol. %, or greater than or equal to 6.0 mol. %, or greater than or equal to 10.0 mol. %, or greater than or equal to 20.0 mol. %. In some other embodiments, the glass composition may have a sum of Na₂O+K₂O less than or equal to 30.0 mol. %, or less than or equal to 20.0 mol. %, or less than or equal to 11.0 mol. %, or less than or equal to 10.0 mol. %. In some more embodiments, the glass composition may have a sum of Na₂O+K₂O greater than or equal to 1.0 mol. % and less than or equal to 30.0 mol. %, or greater than or equal to 1.0 mol. % and less than or equal to 20.0 mol. %, or greater than or equal to 1.0 mol. % and less than or equal to 11.0 mol. %, or greater than or equal to 1.0 mol. % and less than or equal to 10.0 mol. %, or greater than or equal to 6.0 mol. % and less than or equal to 30.0 mol. %, or greater than or equal to 6.0 mol. % and less than or equal to 20.0 mol. %, or greater than or equal to 6.0 mol. % and less than or equal to 11.0 mol. %, or greater than or equal to 6.0 mol. % and less than or equal to 10.0 mol. %, or greater than or equal to 10.0 mol. % and less than or equal to 30.0 mol. %, or greater than or equal to 10.0 mol. % and less than or equal to 20.0 mol. %, or greater than or equal to 10.0 mol. % and less than or equal to 11.0 mol. %.

In some embodiments to protect the glass from devitrification, it may be desirable for the glass composition to include more K₂O than Na₂O. In embodiments, the glass composition may have a difference K₂O−Na₂O greater than or equal to 0.00 mol. %, or greater than or equal to 0.25 mol. %, or greater than or equal to 0.50 mol. %, or greater than or equal to 1.0 mol. %, or greater than or equal to 1.50 mol. %, or greater than or equal 2.0 mol. %, or greater than or equal to 3.0 mol. %, or greater than or equal to 4.0 mol. %, or greater than or equal 5.0 mol. %, or greater than or equal to 7.0 mol. %, or greater than or equal to 9.0 mol. %. In some other embodiments, the glass composition may have a difference K₂O−Na₂O less than or equal to 15.0 mol. %, or less than or equal to 12.0 mol. %, or less than or equal to 10.0 mol. %, or less than or equal to 8.0 mol. %. In some more embodiments, the glass composition may have a difference K₂O−Na₂O greater than or equal to 0.0 mol. % and less than or equal to 15.0 mol. %, or greater than or equal to 0.50 mol. % and less than or equal to 12.0 mol. %, or greater than or equal to 1.0 mol. % and less than or equal to 10.0 mol. %, or greater than or equal to 2.0 mol. % and less than or equal to 8.0 mol. %.

In some embodiments to protect the glass from devitrification, it may be desirable for the glass composition to include more Li₂O than Na₂O. In embodiments, the glass composition may have a difference Li₂O−Na₂O greater than or equal to 0.00 mol. %, or greater than or equal to 0.25 mol. %, or greater than or equal to 0.50 mol. %, or greater than or equal to 0.75 mol. %, or greater than or equal to 1.00 mol. %, or greater than or equal 1.25 mol. %, or greater than or equal to 1.50 mol. %, or greater than or equal to 1.75 mol. %, or greater than or equal 2.00 mol. %. In some other embodiments, the glass composition may have a difference Li₂O−Na₂O less than or equal to 5.0 mol. %, or less than or equal to 4.0 mol. %, or less than or equal to 3.0 mol. %, or less than or equal to 2.0 mol. %. In some more embodiments, the glass composition may have a difference Li₂O−Na₂O greater than or equal to 0.0 mol. % and less than or equal to 5.0 mol. %, or greater than or equal to 0.25 mol. % and less than or equal to 4.0 mol. %, or greater than or equal to 0.50 mol. % and less than or equal to 3.0 mol. %.

In some embodiments, to control devitrification, it may be desirable for the glass compositionto have limitations for a sum of Li₂O+Na₂O+K₂O. In embodiments, the glass composition may have a sum of Li₂O+Na₂O+K₂O greater than or equal to 0.0 mol. %, or greater than or equal to 1.0 mol. %, or greater than or equal to 2.0 mol. %, or greater than or equal to 4.0 mol. %, or greater than or equal to 6.0 mol. %, or greater than or equal 8.0 mol. %, or greater than or equal to 10.0 mol. %, or greater than or equal to 12.0 mol. %, or greater than or equal 14.0 mol. %, or greater than or equal to 15.0 mol. %. In some other embodiments, the glass composition may have a sum of Li₂O+Na₂O+K₂O less than or equal to 25.0 mol. %, or less than or equal to 22.0 mol. %, or less than or equal to 20.0 mol. %, or less than or equal to 17.0 mol. %. In some more embodiments, the glass composition may have a sum of Li₂O+Na₂O+K₂O greater than or equal to 0.0 mol. % and less than or equal to 25.0 mol. %, or greater than or equal to 5.0 mol. % and less than or equal to 25.0 mol. %, or greater than or equal to 10.0 mol. % and less than or equal to 25.0 mol. %, or greater than or equal to 15.0 mol. % and less than or equal to 25.0 mol. %, or greater than or equal to 1.00 mol. % and less than or equal to 22.0 mol. %, or greater than or equal to 2.0 mol. % and less than or equal to 20.0 mol. %, or greater than or equal to 4.0 mol. % and less than or equal to 17.0 mol. %.

In some embodiments, to control devitrification, the glass composition may have limitations for the amount of Na₂O. In embodiments, the glass composition may have an amount of Na₂O greater than or equal to 0.00 mol. %, or greater than or equal to 0.25 mol. %, or greater than or equal to 0.50 mol. %. In some other embodiments, the glass composition may have an amount of Na₂O less than or equal to 5.0 mol. %, or less than or equal to 4.0 mol. %, or less than or equal to 3.0 mol. %, or less than or equal to 2.0 mol. %, or less than or equal to 1.5 mol. %, or less than or equal to 1.0 mol. %, or less than or equal to 0.50 mol. %, or less than or equal to 0.25 mol. %. In embodiments, the glass composition is substantially free of Na₂O. In some more embodiments, the glass composition may have an amount of Na₂O greater than or equal to 0.0 mol. % and less than or equal to 5.0 mol. %, greater than or equal to 0.0 mol. % and less than or equal to 2.0 mol. %, or greater than or equal to 0.0 mol. % and less than or equal to 0.5 mol. %, or greater than or equal to 0.10 mol. % and less than or equal to 3.0 mol. %, or greater than or equal to 0.20 mol. % and less than or equal to 2.0 mol. %.

In some embodiments, glass composition may have limitations for a ratio P₂O₅/(TiO₂+Nb₂O₅). The ratio P₂O₅/(TiO₂+Nb₂O₅) characterizes the balance between the glass-forming ability (or durability against devitrification) provided by P₂O₅ and high refractive index provided by TiO₂ and Nb₂O₅. The higher the ratio P₂O₅/(TiO₂+Nb₂O₅), the better the glass-forming ability is, but the more difficult it is to reach high refractive index. Accordingly, for the glasses of the present disclosure with high refractive index, it is challenging to maintain the high ratio P₂O₅/(TiO₂+Nb₂O₅). However, a minimum value of this ratio, at least, greater than or equal to 0.30, may be needed to inhibit devitrification and/or promote glass forming. In the present disclosure, unless otherwise specified, the quantity P₂O₅/(TiO₂+Nb₂O₅) is expressed in terms of a ratio of mol. %. In some embodiments, the glass may have a ratio P₂O₅/(TiO₂+Nb₂O₅) greater than or equal to 0.30, or greater than or equal to 0.40, or greater than or equal to 0.45, or greater than or equal to 0.46, or greater than or equal to 0.47, or greater than or equal to 0.49, or greater than or equal to 0.50, or greater than or equal to 0.51, or greater than or equal to 0.52, or greater than or equal to 0.53, or greater than or equal to 0.54. In some other embodiments, the glass may have a ratio P₂O₅/(TiO₂+Nb₂O₅) less than or equal to 0.58, or less than or equal to 0.55, or less than or equal to 0.53, or less than or equal to 0.51, or less than or equal to 0.50, or less than or equal to 0.40. In some more embodiments, the glass may have a ratio P₂O₅/(TiO₂+Nb₂O₅) greater than or equal to 0.42 and less than or equal to 0.62, or greater than or equal to 0.44 and less than or equal to 0.60, or greater than or equal to 0.46 and less than or equal to 0.58, or greater than or equal to 0.30 and less than or equal to 0.51, or greater than or equal to 0.30 and less than or equal to 0.50, or greater than or equal to 0.30 and less than or equal to 0.40, or greater than or equal to 0.40 and less than or equal to 0.51, or greater than or equal to 0.40 and less than or equal to 0.50, or greater than or equal to 0.45 and less than or equal to 0.51, or greater than or equal to 0.45 and less than or equal to 0.50, or greater than or equal to 0.46 and less than or equal to 0.51, or greater than or equal to 0.46 and less than or equal to 0.50, or greater than or equal to 0.47 and less than or equal to 0.51.

In some embodiments, the glass may have a refractive index at 587.56 nm n_{d} from greater than or equal to 1.8500 to less than or equal to 1.9770 and all ranges and sub-ranges between the foregoing values. In some embodiments, the glass may have the refractive index at 587.56 nm n_{d} greater than or equal to 1.8500, or greater than or equal to 1.8750, or greater than or equal to 1.9000, or greater than or equal to 1.9300, or greater than or equal to 1.9400, or greater than or equal to 1.9470, or greater than or equal to 1.9500, or greater than or equal to 1.9550, or greater than or equal to 1.9570, or greater than or equal to 1.9670. In some other embodiments, the glass may have the refractive index at 587.56 nm n_{d} less than or equal to 1.9770, or less than or equal to 1.9700, or less than or equal to 1.9670, or less than or equal to 1.9660, or less than or equal to 1.9570, or less than or equal to 1.9500, or less than or equal to 1.9470. In some more embodiments, the glass may have the refractive index at 587.56 nm n_{d} greater than or equal to 1.9000 and less than or equal to 1.9770, or greater than or equal to 1.9000 and less than or equal to 1.9470, or greater than or equal to 1.9300 and less than or equal to 1.9470.

In some embodiments, the glass may have a refractive index parameter Pₙ from greater than or equal to 1.8500 to less than or equal to 1.9770 and all ranges and sub-ranges between the foregoing values. In some embodiments, the glass may have the refractive parameter Pₙ greater than or equal to 1.8500, or greater than or equal to 1.8750, or greater than or equal to 1.9000, or greater than or equal to 1.9300, or greater than or equal to 1.9400, or greater than or equal to 1.9470, or greater than or equal to 1.9500, or greater than or equal to 1.9550, or greater than or equal to 1.9570, or greater than or equal to 1.9670. In some other embodiments, the glass may have the parameter Pₙ less than or equal to 1.9770, or less than or equal to 1.9700, or less than or equal to 1.9670, or less than or equal to 1.9660,or less than or equal to 1.9570, or less than or equal to 1.9500, or less than or equal to 1.9470. In some more embodiments, the glass may have the refractive index parameter Pₙ greater than or equal to 1.9000 and less than or equal to 1.9770, or greater than or equal to 1.9000 and less than or equal to 1.9470, or greater than or equal to 1.9300 and less than or equal to 1.9470

In some embodiments, the glass may have a density at room temperature d_{RT} from greater than or equal to 0.0 g/cm³ to less than or equal to 3.81 g/cm³ and all ranges and sub-ranges between the foregoing values. In some embodiments, the glass may have the density at room temperature d_{RT} greater than or equal to 1.00 g/cm³, or greater than or equal to 2.00 g/cm³, or greater than or equal to 3.40 g/cm³, or greater than or equal to 3.59 g/cm³. In some other embodiments, the glass may have the density at room temperature d_{RT} less than or equal to 3.81 g/cm³, or less than or equal to 3.70 g/cm³, or less than or equal to 3.60 g/cm³, or less than or equal to 3.50 g/cm³, or less than or equal to 3.40 g/cm³. In some more embodiments, the glass may have the density at room temperature d_{RT} greater than or equal to 2.00 g/cm³ and less than or equal to 3.80 g/cm³, or greater than or equal to 2.10 g/cm³ and less than or equal to 3.80 g/cm³, or greater than or equal to 2.25 g/cm³ and less than or equal to 3.80 g/cm³, or greater than or equal to 2.50 g/cm³ and less than or equal to 3.70 g/cm³, or greater than or equal to 2.75 g/cm³ and less than or equal to 3.60 g/cm³.

In some embodiments, the glass may have a density parameter P_{d} greater than or equal to 2.00 g/cm³, or greater than or equal to 3.40 g/cm³, or greater than or equal to 3.59 g/cm³. In some other embodiments, the glass may have the density parameter P_{d} less than or equal to 3.81 g/cm³, or less than or equal to 3.70 g/cm³, or less than or equal to 3.60 g/cm³, or less than or equal to 3.50 g/cm³, or less than or equal to 3.40 g/cm³. In some more embodiments, the glass may have the density parameter P_{d} greater than or equal to 2.00 g/cm³ and less than or equal to 3.80 g/cm³, or greater than or equal to 2.10 g/cm³ and less than or equal to 3.80 g/cm³, or greater than or equal to 2.25 g/cm³ and less than or equal to 3.80 g/cm³, or greater than or equal to 2.50 g/cm³ and less than or equal to 3.70 g/cm³, or greater than or equal to 2.75 g/cm³ and less than or equal to 3.60 g/cm³.

In some embodiments, the glass may have a refractive index to density ratio (“refraction”) (n_{d}−1)/d_{RT} [cm³/g] greater than or equal to 0.24. In some embodiments, the glass may have the refractive index to density ratio (n_{d}−1)/d_{RT} [cm³/g] greater than or equal to 0.25, or greater than or equal to 0.26, or in the range from 0.24 to 0.27.

In some embodiments, the glass may have a refraction parameter P_{ref} [cm³/g] greater than or equal to 0.24. In some embodiments, the glass may have the refractive parameter P_{ref} [cm³/g] greater than or equal to 0.25, or greater than or equal to 0.26, or in the range from 0.24 to 0.27.

In some embodiments, the glass may have an Abbe number ν_{d} less than or equal to 19.00. In some other embodiments, the glass may have the Abbe number ν_{d} less than or equal to 18.75, or less than or equal to 18.50, or less than or equal to 18.25, or less than or equal to 18.00, or less than or equal to 17.75, or greater than or equal to 16.00, or greater than or equal to 16.50, or greater than or equal to 17.00, or greater than or equal to 17.25.

In some embodiments, the glass may have a dispersion parameter P_{ν} less than or equal to 19.00. In some other embodiments, the glass may have a dispersion parameter P_{ν} less than or equal to 18.75, or less than or equal to 18.50, or less than or equal to 18.25, or less than or equal to 18.00, or less than or equal to 17.75, or greater than or equal to 16.00, or greater than or equal to 16.50, or greater than or equal to 17.00, or greater than or equal to 17.25.

In some embodiments, the glass may have a liquidus temperature T_{liq} less than or equal to 1200° C. In some other embodiments, the glass may have the liquidus temperature T_{liq} less than or equal to 1175° C., or less than or equal to 1150° C., or less than or equal to 1125° C., or less than or equal to 1100° C., or less than or equal to 1075° C.

In some embodiments, the glass may have a glass transition temperature T_{g} greater than or equal to 600° C. In some embodiments, the glass may have the glass transition temperature T_{g} greater than or equal to 620° C., or greater than or equal to 640° C., or greater than or equal to 650° C.

In some embodiments, the glass may have the density at room temperature d_{RT} less than or equal to 4.50. In some other embodiments, the glass may have the d_{RT} less than or equal to 4.50 or less than or equal to 4.50, or less than or equal to 3.80.

Refractive index n_{d}, density d_{RT}, Abbe number ν_{d} and refraction (n_{d}−1)/d_{RT} are properties of a glass that can be predicted from the glass composition. A linear regression analysis of the Exemplary Glasses of the present disclosure in the EXAMPLES section below and other glass compositions reported in the literature was performed to determine equations that can predict the composition dependences of the refractive index n_{d}, density d_{RT}, Abbe number ν_{d}, and refraction (n_{d}−1)/d_{RT}.

The training dataset of glass compositions satisfying the criteria specified in Table 1 below and having measured values of the properties of interest, about 100 glass compositions for each property (n_{d}, density d_{RT}, ν_{d} and refraction), was randomly selected from the literature data presented in the publicly available SciGlass Information System database and from the Exemplary Glasses from the embodiments presented herein. The linear regression analysis on the above-specified dataset was used to determine the formulas (I)-(IV) presented in Table 2 below for predictive parameters Pₙ, P_{d}, P_{ν}, and P_{ref}, respectively. Another subset of glass compositions satisfying the criteria of Table 1 was used as a validation set to evaluate the ability to interpolate within the compositional limits of Table 1 and was used to establish the standard deviations specified in the Table 2. An external dataset of prior art glass compositions, also randomly selected from the SciGlass Information System database, was used to evaluate the ability to predict the properties (n_{d}, d_{RT}, ν_{d}, and refraction) outside of the compositional limits of Table 1 with reasonable accuracy. Multiple iterations of this process were performed in order to determine the best formula for each property (n_{d}, d_{RT}, ν_{d}, and refraction). Formulas (I)-(IV) in Table 2 are the result of the analysis.

The data for the Comparative Glass compositions used in the linear regression modeling, including the training dataset, validation dataset and external dataset were obtained from the publically available SciGlass Information System database. Formulas (I), (II), (III) and (IV) below were obtained from the linear regression analysis and used to predict the refractive index n_{d}, density, Abbe number and refraction, respectively, of the glasses:

$${P}_{n} = 1.82063 - 0.0023121 * {AlO}_{3} - 0.003381 * {B}_{2} {O}_{3} - 0.00024425 * BaO + 0.0088252 * {Bi}_{2} {O}_{3} - 0.00051393 * CaO + 0.00083458 * CdO - 0.0021789 * {Cs}_{2} O - 0.0015444 * {GeO}_{2} - 0.0037344 * {K}_{2} O + 0.0022272 * {La}_{2} {O}_{3} - 0.0016171 * {Li}_{2} O - 0.0015687 * MgO + 0.0026917 * {MoO}_{3} - 0.0023954 * {Na}_{2} O + 0.007544 * {Nb}_{2} {O}_{5} - 0.0049543 * {P}_{2} {O}_{5} + 0.0033051 * PbO - 0.0029543 * {SiO}_{2} - 0.00038966 * SrO + 0.0069184 * {Ta}_{2} {O}_{5} + 0.0025768 * {TeO}_{2} + 0.0037599 * {TiO}_{2} + 0.0041441 * {V}_{2} {O}_{5} + 0.0032619 * {WO}_{3} + 0.0024821 * {ZrO}_{2} , \qquad ( I )$$

$${P}_{d} = 3.98457 - 0.015773 * {Al}_{2} {O}_{3} - 0.014501 * {B}_{2} {O}_{3} + 0.019328 * BaO + 0.060758 * {Bi}_{2} {O}_{3} - 0.0012685 * CaO + 0.023111 * CdO + 0.0053184 * {Cs}_{2} O + 0.011488 * {Ga}_{2} {O}_{3} - 0.0015416 * {GeO}_{2} - 0.013342 * {K}_{2} O + 0.058319 * {La}_{2} {O}_{3} - 0.007918 * {Li}_{2} O - 0.0024123 * MgO - 0.0024413 * {MoO}_{3} - 0.0082226 * {Na}_{2} O + 0.0084961 * {Nb}_{2} {O}_{5} - 0.020501 * {P}_{2} {O}_{5} + 0.038898 * PbO - 0.01272 * {SiO}_{2} + 0.013948 * SrO + 0.047924 * {Ta}_{2} {O}_{5} + 0.011248 * {YeO}_{2} - 0.0092491 * {V}_{2} {O}_{5} + 0.028913 * {WO}_{3} + 0.0074702 * ZnO + 0.0096721 * {ZrO}_{2} , \qquad ( II )$$

$${P}_{v} = exp ( 2.11 + 0.0438 * ( exp ( 3.2598 + 0.0072248 * {Al}_{2} {O}_{3} + 0.0055494 * {B}_{2} {O}_{3} + 0.0024164 * BaO - 0.00849 * {Bi}_{2} {O}_{3} + 0.0029812 * CaO + 0.0092768 * CdO + 0.0099824 * {Ga}_{2} {O}_{3} - 0.0038579 * {GeO}_{2} + 0.0028062 * {K}_{2} O + 0.0031951 * {Li}_{2} O + 0.0027011 * MgO + 0.007976 * {MoO}_{3} + 0.0028705 * {Na}_{2} O - 0.013374 * {Nb}_{2} {O}_{5} + 0.0072007 * {P}_{2} {O}_{5} - 0.0049796 * PbO + 0.0032241 * {SiO}_{2} + 0.0050024 * SrO - 0.002136 * {Ta}_{2} {O}_{5} - 0.0032329 * {TeO}_{2} - 0.009788 * {TiO}_{2} + 0.0074782 * {V}_{2} {O}_{5} - 0.00057095 * {WO}_{3} + 0.0032826 * ZnO + 0.009302 * {ZrO}_{2} ) ) ) , \qquad ( III )$$

$${P}_{ref} = 0.223637 + 0.0010703 * {Nb}_{2} {O}_{5} - 0.00041688 * {P}_{2} {O}_{5} + 0.00088482 * {TiO}_{2} + 0.000054956 * CaO - 0.00029243 * {K}_{2} O - 0.0008347 * BaO - 0.00023739 * {Na}_{2} O + 0.000082792 * {Li}_{2} O - 0.0012487 * {WO}_{3} - 0.00042393 * ZnO - 0.00059152 * SrO - 0.00018266 * MgO - 0.0014091 * {Bi}_{2} {O}_{3} - 0.0014895 * {Ta}_{2} {O}_{5} - 0.00021842 * {SiO}_{2} - 0.00024788 * {ZrO}_{2} - 0.00014801 * {B}_{2} {O}_{3} - 0.000060848 * {TeO}_{2} - 0.00085564 * PbO - 0.00042429 * {GeO}_{2} - 0.0015439 * {Tl}_{2} O - 0.0012936 * {Ag}_{2} O - 0.00089356 * {Cu}_{2} O - 0.00039278 * CuO + 0.00017895 * {As}_{2} {O}_{3} - 0.00011802 * {Sb}_{2} {O}_{3} . \qquad ( IV )$$

In Formulas (I), (II), (III) and (IV) and Tables 1 and 2, refractive index parameter Pₙ is a parameter that predicts the refractive index at 587.56 nm, calculated from the components of the glass composition expressed in mol. %; density parameter P_{d} is a parameter that predicts the density at room temperature d_{RT} [g/cm³], calculated from the components of the glass composition expressed in mol. %; dispersion parameter P_{ν} is a parameter that predicts the Abbe number ν_{d}, calculated from the components of the glass composition expressed in mol. %; and refraction parameter P_{ref} is a parameter that predicts the refractive index to density ratio (n_{d}−1)/d_{RT} (“refraction”) [cm³/g], calculated from the components of the glass composition expressed in mol. %. For dispersion parameter P_{ν}, logarithmic scale was applied when performing the regression analysis.

In Formulas (I), (II), (III) and (IV), each component of the glass composition is listed in terms of its chemical formula, where the chemical formula refers to the concentration of the component expressed in mol. %. For example, for purposes of Formulas (I), (II), (III) and (IV), Al₂O₃ refers to the concentration of Al₂O₃, expressed in mol. %, in the glass composition. It is understood that not all components listed in Formulas (I), (II), (III) and (IV) are necessarily present in a particular glass composition and that Formulas (I), (II), (III) and (IV) are equally valid for glass compositions that contain less than all of the components listed in the formulas. It is further understood that Formulas (I), (II), (III) and (IV) are also valid for glass compositions within the scope and claims of the present disclosure that contain components in addition to the components listed in the formulas. If a component listed in Formulas (I), (II), (III) and (IV) is absent in a particular glass composition, the concentration of the component in the glass composition is 0 mol. % and the contribution of the component to the value calculated from the formulas is zero. In Table 1, RₘOₙ is a total sum of all oxides, R₂O is a total sum of monovalent metal oxides and RO is a total sum of divalent metal oxides.

TABLE 1
Composition Space Used for Modeling

| | Property | | | | | | | |
|---|---|---|---|---|---|---|---|---|
| | n_{d} | | d_{RT}, g/cm³ | | ν_{d} | | (n_{d} − 1)/d_{RT}, cm³/g | |
| | Component limits | | | | | | | |
| | Min, | Max, | Min, | Max, | Min, | Max, | Min, | Max, |
| | mol. % | mol. % | mol. % | mol. % | mol. % | mol. % | mol. % | mol. % |
| Nb₂O₅ | 5 | 60 | 0 | 60 | 5 | 60 | 5 | 60 |
| P₂O₅ | 10 | 30 | 10 | 30 | 10 | 30 | 10 | 30 |
| TiO₂ | 0 | 40 | 0 | 40 | 0 | 40 | 0 | 40 |
| CaO | 0 | 40 | 0 | 40 | 0 | 40 | 0 | 40 |
| K₂O | 0 | 20 | 0 | 20 | 0 | 20 | 0 | 20 |
| BaO | 0 | 20 | 0 | 20 | 0 | 20 | 0 | 20 |
| Na₂O | 0 | 30 | 0 | 30 | 0 | 30 | 0 | 30 |
| SiO₂ | 0 | 20 | 0 | 20 | 0 | 20 | 0 | 20 |
| ZnO | 0 | 20 | 0 | 20 | 0 | 20 | 0 | 20 |
| Li₂O | 0 | 10 | 0 | 10 | 0 | 10 | 0 | 10 |
| SrO | 0 | 30 | 0 | 30 | 0 | 30 | 0 | 30 |
| ZrO₂ | 0 | 10 | 0 | 10 | 0 | 10 | 0 | 10 |
| WO₃ | 0 | 15 | 0 | 15 | 0 | 15 | 0 | 15 |
| MgO | 0 | 10 | 0 | 10 | 0 | 10 | 0 | 10 |
| B₂O₃ | 0 | 10 | 0 | 10 | 0 | 10 | 0 | 10 |
| Al₂O₃ | 0 | 5 | 0 | 5 | 0 | 5 | 0 | 5 |
| RₘOₙ | 99 | Not | 99 | Not | 99 | Not | 99 | Not |
| | | limited | | limited | | limited | | limited |
| TeO₂ + PbO + GeO₂ + | 0 | 20 | 0 | 20 | 0 | 20 | 0 | 20 |
| Tl₂O | | | | | | | | |
| Ag₂O + Cu₂O + CuO + | 0 | 15 | 0 | 15 | 0 | 15 | 0 | 15 |
| As₂O₃ + Sb₂O₃ | | | | | | | | |
| P₂O₅ − SiO₂ | 10 | Not | 10 | Not | 10 | Not | 10 | Not |
| | | limited | | limited | | limited | | limited |
| TiO₂ + Nb₂O₅ + WO₃ + | 25 | Not | Not | Not | Not | Not | 25 | Not |
| GeO₂ + Bi₂O₃ + | | limited | limited | limited | limited | limited | | limited |
| TeO₂ | | | | | | | | |
| R₂O + RO − P₂O₅ | −10 | Not | Not | Not | Not | Not | Not | Not |
| | | limited | limited | limited | limited | limited | limited | limited |
| R₂O + RO − TiO₂ | −5 | Not | Not | Not | Not | Not | Not | Not |
| | | limited | limited | limited | limited | limited | limited | limited |
| V₂O₅ | Not | Not | 0 | 80 | Not | Not | Not | Not |
| | limited | limited | | | limited | limited | limited | limited |
| TiO₂ + Nb₂O₅ + WO₃ + | Not | Not | 25 | Not | Not | Not | Not | Not |
| V₂O₅ + GeO₂ + | limited | limited | | limited | limited | limited | limited | limited |
| Bi₂O₃ + TeO₂ | | | | | | | | |
| Other species | 0 | Not | 0 | Not | 0 | Not | 0 | Not |
| | | limited | | limited | | limited | | limited |

TABLE 2
Property prediction models

| | | | Predicting | Regression | Composition | Standard |
|---|---|---|---|---|---|---|
| Property | Abbreviation | Unit | Parameter | Formula | Unit | Deviation |
| Refractive index at | n_{d} | | Pₙ | Formula (I) | Mol. % | 0.021 |
| 587.56 nm | | | | | | |
| Density at room | d_{RT} | g/cm³ | P_{d} | Formula (II) | Mol. % | 0.20 |
| temperature | | | | | | |
| Abbe number | ν_{d} | | P_{ν} | Formula (III) | Mol. % | 0.66 |
| Refractive index to | (n_{d} − 1)/d_{RT} | cm³/g | P_{ref} | Formula (IV) | Mol. % | 0.0049 |
| density ratio | | | | | | |
| (“refraction”) | | | | | | |

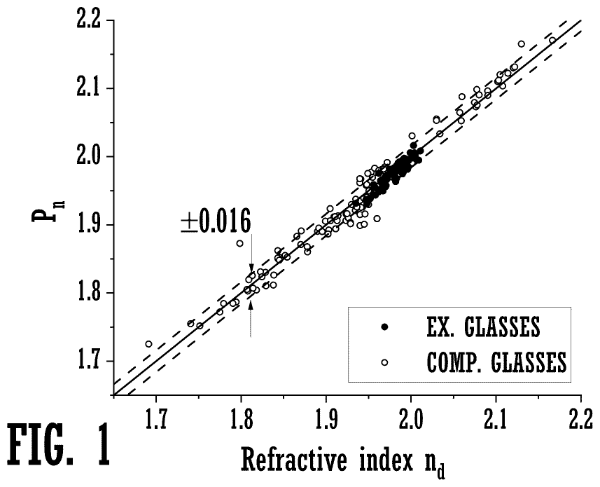

FIG. 1 is a plot of the parameter Pₙ calculated by Formula (I) as a function of measured refractive index n_{d} for some Comparative Glasses (“Comp. Glasses”) taken from the literature and some Exemplary Glasses (“Ex. Glasses”). As illustrated by the data in FIG. 1, the compositional dependence of the parameter Pₙ had a standard deviation within a range of ±0.021 unit of the measured na for the majority of glasses.

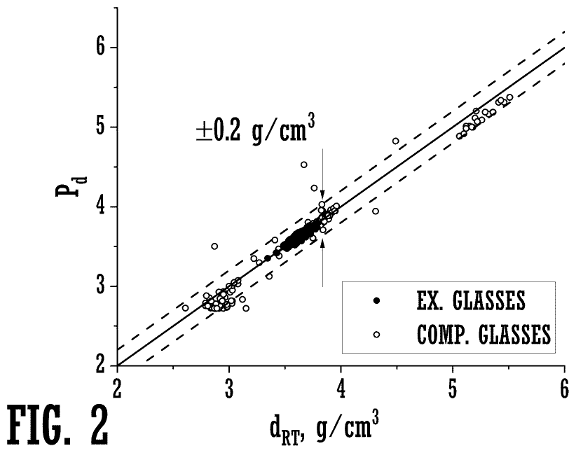

FIG. 2 is a plot of the parameter P_{d} calculated by Formula (II) as a function of measured density d_{RT} for some Comparative Glasses (“Comp. Glasses”) taken from the literature and some Exemplary Glasses (“Ex. Glasses”). As illustrated by the data in FIG. 2, the compositional dependence of the parameter P_{d} had a standard deviation within a range of ±0.20 unit of the measured d_{RT} for the majority of glasses.

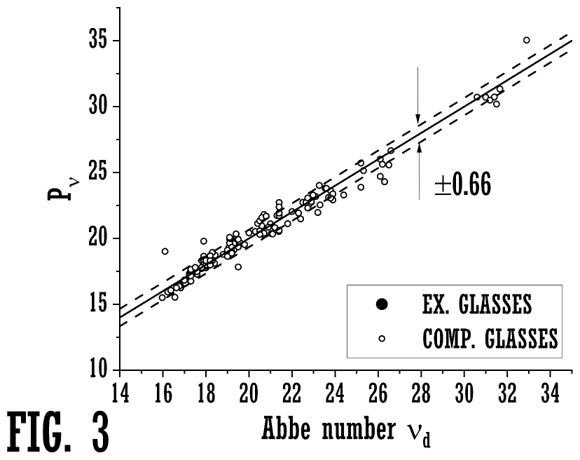

FIG. 3 is a plot of the parameter P_{ν} calculated by Formula (III) as a function of measured Abbe number ν_{d} for some Comparative Glasses (“Comp. Glasses”) taken from the literature and some Exemplary Glasses (“Ex. Glasses”). As illustrated by the data in FIG. 3, the compositional dependence of the parameter P_{ν} had a standard deviation within a range of ±0.66 unit of the measured ν_{d} for the majority of glasses.

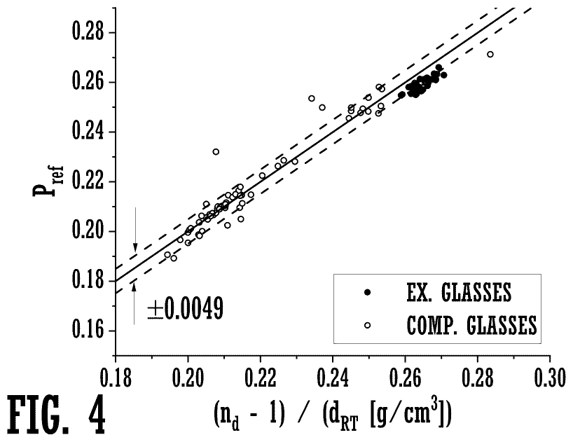

FIG. 4 is a plot of the parameter P_{ref} calculated by Formula (IV) as a function of measured refraction (n_{d}−1)/d_{RT} for some Comparative Glasses (“Comp. Glasses”) taken from the literature and some Exemplary Glasses (“Ex. Glasses”). As illustrated by the data in FIG. 4, the compositional dependence of the parameter P_{ref} had a standard deviation within a range of ±0.0049 unit of the measured (n_{d}−1)/d_{RT} for the majority of glasses.

Table 3 identifies the combination of components and their respective amounts according to some embodiments of the present disclosure. The Exemplary Glasses A in Table 3 may include additional components according to any aspects of the present disclosure as described herein.

TABLE 3
Exemplary Glasses A

| Component | Amount (mol. %) | |
|---|---|---|
| P₂O₅ | ≥25.5 | mol. % |
| Nb₂O₅ | ≥20.0 | mol. % |
| TiO₂ | 0.5 to 40.0 | mol. % |
| Li₂O | 0.1 to 8.0 | mol. % |
| Sum of (Na₂O + K₂O) | 1.0 to 30.0 | mol. % |

Exemplary Glasses A according to embodiments of the present disclosure may satisfy the following condition:

$${P}_{2} {O}_{5} / \{ Ti {O}_{2} + N {b}_{2} {O}_{5} ) [ mol . \% ] \geq 0.3 ,$$

where the chemical formulas refer to the amounts of the components in the glass, expressed in mol. %.

According to some embodiments of the present disclosure, Exemplary Glasses A may also satisfy the following condition:

$${K}_{2} O - N {a}_{2} O [ mol . \% ] \geq 0. ,$$

where the chemical formulas refer to the amounts of the components in the glass, expressed in mol. %.

According to some embodiments of the present disclosure, Exemplary Glasses A may also have a refractive index at 587.56 nm n_{d} or refractive index parameter Pₙ of greater than or equal to 1.9000.

According to some embodiments of the present disclosure, Exemplary Glasses A may also have a density at room temperature d_{RT} [g/cm³] or density parameter P_{d} of less than or equal to 3.80.

According to some embodiments of the present disclosure, Exemplary Glasses A may also have an Abbe number ν_{d} or dispersion parameter P_{ν} of less than or equal to 18.00.

According to some embodiments of the present disclosure, Exemplary Glasses A may also have a refraction (n_{d}−1)/d_{RT} [cm³/g] or refraction parameter P_{ref} of greater than or equal to 0.24.

### EXAMPLES

The following examples 1-49 in Table 4 describe various features and advantages provided by the disclosure, and are in no way intended to limit the invention and appended claims. All compositions in Table 4 are listed in mol. % and the values listed for Pₙ, P_{d}, P_{ν}, and P_{ref} were computed from Formulas (I)-(IV), respectively.

The exemplary glasses of Table 4 were prepared using high-purity oxide and phosphate raw materials in the form of fine powders. Nb₂O₅ was batched as niobium oxide, which in some cases included a non-negligible amount of tantalum oxide, Ta₂O₅. TiO₂ was batched as a mixture of titanium dioxide and titanium pyrophosphate, the latter being used to obtain the high P₂O₅ contents of some of the inventive glasses. Li₂O and K₂O were batched as monobasic orthophosphates, LiH₂PO₄ and KH₂PO₄.BaO was batched as either barium metaphosphate, BaPO₃, or as barium dihydrogen phosphate, Ba(H₂PO₄)₂.CaO was batched as calcium dihydrogen phosphate monohydrate, Ca(H₂PO₄)₂.H₂O. ZnO was batched as zinc pyrophosphate, ZnP₂O₇. Batches were prepared by weighing oxides into clean plastic bottles, adding alumina media to aid in breaking up soft agglomerates, and mixing using a Turbula® shaker mixer for one hour. The mixtures were transferred from the bottle to a crucible prior to melting. For most of the examples, the crucible material was fused quartz, and as a result a small amount of SiO₂ (≤1 mol %) is incorporated into those glasses. When fused quartz is used as a crucible material, the glasses described herein are free of platinum (Pt). In some of the examples, the crucible material was platinum. However, despite its reputation for being chemically inert, a very small amount of platinum is incorporated into the inventive glasses when it is used as a crucible material, resulting in appreciable absorption at visible wavelengths. Some contact with platinum may be required to enable manufacturing: however, the amount of platinum that is incorporated into the glass as a result of such contact is expected to be less than 5.0 ppm, more preferably <1.0 ppm, to achieve the high transmittance at visible wavelengths. In preferred embodiments, the concentration of Pt in glasses in accordance with the present disclosure is less than or equal to 5.0 ppm, or less than or equal to 4.0 ppm, or less than or equal to 3.5 ppm, or less than or equal to 3.0 ppm, or less than or equal to 2.5 ppm, or less than or equal to 2.0 ppm, or less than or equal to 1.5 ppm, or less than or equal to 1.0 ppm.

The crucibles were placed into refractory outer crucibles, covered with refractory lids, and loaded into a furnace heated by silicon carbide glow bars. The furnace temperature was 1300° C., though it fell below this briefly after loading samples. A typical melt schedule is as follow. Nine crucibles containing 1 kg of batch each were loaded simultaneously into the furnace at 1300° C. After 45 min, the crucibles were removed from the furnace one at a time, the lids were removed, and the glass was poured onto a steel plate. The resulting patty of still-incandescent glass was plunged into a bucket of cold water to shatter it into fine cullet. The cullet was dried, loaded into a crucible of the same type used for the first melt, covered, and melted again at 1300° C. for 45 minutes. After this time, the crucible was removed from the furnace, the lid was removed, and the glass was poured into a mold. Best results were obtained when the mold was pre-heated to at least 300° C. In some cases, the molten glass was stirred with a rod of fused quartz to maximize homogeneity of the final glass. All glasses were annealed at 650° C. for 2 h, then cooled at approximately 1° C./min to room temperature.

TABLE 4
Exemplary Glass Compositions

| | 1 | 2 | 3 | 4 | 5 | 6 | 7 | 8 | 9 |
|---|---|---|---|---|---|---|---|---|---|
| P₂O₅ | 27 | 28 | 27 | 29 | 29 | 30 | 26 | 30 | 26 |
| TiO₂ | 32.9 | 20 | 25.6 | 22 | 24 | 22 | 22 | 22 | 24 |
| Nb₂O₅ | 27.4 | 35 | 32 | 32 | 32 | 31 | 35 | 33 | 33 |
| Li₂O | 2 | 1 | 2 | 2.26 | 2 | 1 | 1 | 1 | 1 |
| Na₂O | 0 | 0 | 0 | 0 | 0 | 0 | 0 | 0 | 0 |
| K₂O | 4.35 | 7 | 5.7 | 7.37 | 6.5 | 7 | 7 | 6 | 7 |
| CaO | 0 | 0 | 0 | 0 | 0 | 0 | 0 | 0 | 0 |
| BaO | 6.35 | 7 | 7.7 | 7.37 | 6.5 | 7 | 7 | 6 | 7 |
| ZnO | 0 | 2 | 0 | 0 | 0 | 2 | 2 | 2 | 2 |
| Ta₂O₅ | 0 | 0 | 0 | 0 | 0 | 0 | 0 | 0 | 0 |
| Al₂O₃ | 0 | 0 | 0 | 0 | 0 | 0 | 0 | 0 | 0 |
| Fe₂O₃ | 0 | 0 | 0 | 0 | 0 | 0 | 0 | 0 | 0 |
| P₂O₅/(TiO₂ + Nb₂O₅) | 0.448 | 0.509 | 0.469 | 0.537 | 0.518 | 0.566 | 0.456 | 0.545 | 0.456 |
| Na₂O + K₂O | 4.35 | 7 | 5.7 | 7.37 | 6.5 | 7 | 7 | 6 | 7 |
| K₂O − Na₂O | 4.35 | 7 | 5.7 | 7.37 | 6.5 | 7 | 7 | 6 | 7 |
| Pₙ | 1.9962 | 1.9917 | 1.9981 | 1.9681 | 1.9795 | 1.9591 | 2.0091 | 1.9782 | 2.0015 |
| P_{d} | 3.7127 | 3.7568 | 3.7599 | 3.6881 | 3.685 | 3.6818 | 3.7978 | 3.6928 | 3.7808 |
| | 10 | 11 | 12 | 13 | 14 | 15 | 16 | 17 | 18 |
| P₂O₅ | 28.29 | 26 | 29 | 28 | 28 | 28.16 | 28 | 28.71 | 28 |
| TiO₂ | 15.61 | 22 | 20 | 24 | 31 | 21.36 | 22 | 21.78 | 33 |
| Nb₂O₅ | 38.05 | 35 | 34 | 33 | 25 | 33.01 | 31 | 33.66 | 25 |
| Li₂O | 1.95 | 2 | 2.26 | 2 | 2 | 1.94 | 1 | 1.98 | 2 |
| Na₂O | 0 | 0 | 0 | 0 | 0 | 0 | 0 | 0 | 0 |
| K₂O | 10.24 | 7.5 | 7.37 | 6.5 | 14 | 6.31 | 8 | 6.44 | 6 |
| CaO | 0 | 0 | 0 | 0 | 0 | 0 | 0 | 0 | 0 |
| BaO | 3.41 | 7.5 | 7.37 | 6.5 | 0 | 6.31 | 8 | 6.44 | 6 |
| ZnO | 2.44 | 0 | 0 | 0 | 0 | 2.91 | 2 | 0.99 | 0 |
| Ta₂O₅ | 0 | 0 | 0 | 0 | 0 | 0 | 0 | 0 | 0 |
| Al₂O₃ | 0 | 0 | 0 | 0 | 0 | 0 | 0 | 0 | 0 |
| Fe₂O₃ | 0 | 0 | 0 | 0 | 0 | 0 | 0 | 0 | 0 |
| P₂O₅/(TiO₂ + Nb₂O₅) | 0.527 | 0.456 | 0.537 | 0.491 | 0.5 | 0.518 | 0.528 | 0.518 | 0.483 |
| Na₂O + K₂O | 10.24 | 7.5 | 7.37 | 6.5 | 14 | 6.31 | 8 | 6.44 | 6 |
| K₂O − Na₂O | 10.24 | 7.5 | 7.37 | 6.5 | 14 | 6.31 | 8 | 6.44 | 6 |
| Pₙ | 1.984 | 2.0055 | 1.9757 | 1.992 | 1.9316 | 1.9822 | 1.965 | 1.9854 | 1.9675 |
| P_{d} | 3.6599 | 3.778 | 3.7051 | 3.714 | 3.4203 | 3.7319 | 3.7288 | 3.7122 | 3.643 |
| | 19 | 20 | 21 | 22 | 23 | 24 | 25 | 26 | 27 |
| P₂O₅ | 28 | 28.43 | 29 | 30 | 28 | 27.62 | 28 | 28 | 29 |
| TiO₂ | 22 | 21.57 | 16 | 31 | 31 | 15.24 | 24 | 31 | 24 |
| Nb₂O₅ | 33 | 33.33 | 39 | 25 | 25 | 37.14 | 33 | 27 | 34 |
| Li₂O | 1 | 1.96 | 2 | 2 | 2 | 1.9 | 1 | 2 | 1.74 |
| Na₂O | 0 | 0 | 0 | 0 | 0 | 0 | 0 | 0 | 0 |
| K₂O | 14 | 6.37 | 14 | 6 | 3.5 | 10 | 6 | 6 | 5.63 |
| CaO | 0 | 0 | 0 | 0 | 0 | 0 | 0 | 0 | 0 |
| BaO | 0 | 6.37 | 0 | 6 | 10.5 | 3.33 | 6 | 6 | 5.63 |
| ZnO | 2 | 1.96 | 0 | 0 | 0 | 4.76 | 2 | 0 | 0 |
| Ta₂O₅ | 0 | 0 | 0 | 0 | 0 | 0 | 0 | 0 | 0 |
| Al₂O₃ | 0 | 0 | 0 | 0 | 0 | 0 | 0 | 0 | 0 |
| Fe₂O₃ | 0 | 0 | 0 | 0 | 0 | 0 | 0 | 0 | 0 |
| P₂O₅/(TiO₂ + Nb₂O₅) | 0.509 | 0.518 | 0.527 | 0.536 | 0.5 | 0.527 | 0.491 | 0.483 | 0.5 |
| Na₂O + K₂O | 14 | 6.37 | 14 | 6 | 3.5 | 10 | 6 | 6 | 5.63 |
| K₂O − Na₂O | 14 | 6.37 | 14 | 6 | 3.5 | 10 | 6 | 6 | 5.63 |
| Pₙ | 1.9597 | 1.9838 | 1.9758 | 1.9501 | 1.9682 | 1.98 | 1.9956 | 1.975 | 1.9985 |
| P_{d} | 3.5111 | 3.7222 | 3.5188 | 3.602 | 3.7634 | 3.6853 | 3.7339 | 3.66 | 3.6988 |
| | 28 | 29 | 30 | 31 | 32 | 33 | 34 | 35 | 36 |
| P₂O₅ | 28 | 27 | 29 | 26 | 28 | 29 | 30 | 29 | 29 |
| TiO₂ | 24 | 38.4 | 16 | 33 | 22 | 16 | 31 | 13 | 22 |
| Nb₂O₅ | 31 | 24 | 42 | 25 | 33 | 36 | 23 | 39 | 36 |
| Li₂O | 1 | 2 | 2 | 2 | 1 | 2 | 2 | 2 | 1.74 |
| Na₂O | 0 | 0 | 0 | 0 | 0 | 0 | 0 | 0 | 0 |
| K₂O | 7 | 3.3 | 8.6 | 7 | 7 | 12.7 | 7 | 12.7 | 5.63 |
| CaO | 0 | 0 | 0 | 0 | 0 | 0 | 0 | 0 | 0 |
| BaO | 7 | 5.3 | 2.4 | 7 | 7 | 4.3 | 7 | 4.3 | 5.63 |
| ZnO | 2 | 0 | 0 | 0 | 2 | 0 | 0 | 0 | 0 |
| Ta₂O₅ | 0 | 0 | 0 | 0 | 0 | 0 | 0 | 0 | 0 |
| Al₂O₃ | 0 | 0 | 0 | 0 | 0 | 0 | 0 | 0 | 0 |
| Fe₂O₃ | 0 | 0 | 0 | 0 | 0 | 0 | 0 | 0 | 0 |
| P₂O₅/(TiO₂ + Nb₂O₅) | 0.509 | 0.433 | 0.5 | 0.448 | 0.509 | 0.558 | 0.556 | 0.558 | 0.5 |
| Na₂O + K₂O | 7 | 3.3 | 8.6 | 7 | 7 | 12.7 | 7 | 12.7 | 5.63 |
| K₂O − Na₂O | 7 | 3.3 | 8.6 | 7 | 7 | 12.7 | 7 | 12.7 | 5.63 |
| Pₙ | 1.9765 | 1.9954 | 2.018 | 1.9734 | 1.9841 | 1.957 | 1.931 | 1.9683 | 2.006 |
| P_{d} | 3.7228 | 3.6775 | 3.6627 | 3.69 | 3.7398 | 3.5937 | 3.591 | 3.6192 | 3.7158 |
| | 37 | 38 | 39 | 40 | 41 | 42 | 43 | 44 | 45 |
| P₂O₅ | 28 | 30 | 28 | 28 | 28 | 29 | 30 | 29 | 28 |
| TiO₂ | 29 | 29 | 33 | 22 | 31 | 20 | 20 | 16 | 20 |
| Nb₂O₅ | 25 | 25 | 23 | 33 | 25 | 36 | 33 | 39 | 33 |
| Li₂O | 2 | 2 | 2 | 2 | 2 | 2 | 1 | 2 | 2 |
| Na₂O | 0 | 0 | 0 | 0 | 0 | 0 | 0 | 0 | 0 |
| K₂O | 8 | 7 | 7 | 15 | 7 | 6.5 | 7 | 7 | 8.5 |
| CaO | 0 | 0 | 0 | 0 | 0 | 0 | 0 | 0 | 0 |
| BaO | 8 | 7 | 7 | 0 | 7 | 6.5 | 7 | 7 | 8.5 |
| ZnO | 0 | 0 | 0 | 0 | 0 | 0 | 2 | 0 | 0 |
| Ta₂O₅ | 0 | 0 | 0 | 0 | 0 | 0 | 0 | 0 | 0 |
| Al₂O₃ | 0 | 0 | 0 | 0 | 0 | 0 | 0 | 0 | 0 |
| Fe₂O₃ | 0 | 0 | 0 | 0 | 0 | 0 | 0 | 0 | 0 |
| P₂O₅/(TiO₂ + Nb₂O₅) | 0.519 | 0.556 | 0.5 | 0.509 | 0.5 | 0.518 | 0.566 | 0.527 | 0.528 |
| Na₂O + K₂O | 8 | 7 | 7 | 15 | 7 | 6.5 | 7 | 7 | 8.5 |
| K₂O − Na₂O | 8 | 7 | 7 | 15 | 7 | 6.5 | 7 | 7 | 8.5 |
| Pₙ | 1.9445 | 1.9386 | 1.9484 | 1.9543 | 1.956 | 1.9946 | 1.9667 | 2.0002 | 1.969 |
| P_{d} | 3.655 | 3.608 | 3.632 | 3.4749 | 3.649 | 3.719 | 3.6988 | 3.7475 | 3.726 |
| | 46 | 47 | 48 | 49 | 50 | 51 | 52 | 53 | 54 |
| P₂O₅ | 28 | 28 | 28 | 26 | 28 | 28 | 28 | 26 | 27.88 |
| TiO₂ | 20 | 31 | 29 | 22 | 22 | 31 | 22 | 31 | 21.15 |
| Nb₂O₅ | 33 | 23 | 27 | 33 | 35 | 25 | 33 | 25 | 32.69 |
| Li₂O | 1 | 2 | 2 | 1 | 1 | 2 | 1 | 2 | 1.92 |
| Na₂O | 0 | 0 | 0 | 0 | 0 | 0 | 0 | 0 | 0 |
| K₂O | 8 | 8 | 7 | 8 | 6 | 10.5 | 10.5 | 8 | 6.25 |
| CaO | 0 | 0 | 0 | 0 | 0 | 0 | 0 | 0 | 0 |
| BaO | 8 | 8 | 7 | 8 | 6 | 3.5 | 3.5 | 8 | 6.25 |
| ZnO | 2 | 0 | 0 | 2 | 2 | 0 | 2 | 0 | 3.85 |
| Ta₂O₅ | 0 | 0 | 0 | 0 | 0 | 0 | 0 | 0 | 0 |
| Al₂O₃ | 0 | 0 | 0 | 0 | 0 | 0 | 0 | 0 | 0 |
| Fe₂O₃ | 0 | 0 | 0 | 0 | 0 | 0 | 0 | 0 | 0 |
| P₂O₅/(TiO₂ + Nb₂O₅) | 0.528 | 0.519 | 0.5 | 0.473 | 0.491 | 0.5 | 0.509 | 0.464 | 0.518 |
| Na₂O + K₂O | 8 | 8 | 7 | 8 | 6 | 10.5 | 10.5 | 8 | 6.25 |
| K₂O − Na₂O | 8 | 8 | 7 | 8 | 6 | 10.5 | 10.5 | 8 | 6.25 |
| Pₙ | 1.9726 | 1.9369 | 1.9635 | 1.99 | 2.0032 | 1.9438 | 1.9719 | 1.9619 | 1.9807 |
| P_{d} | 3.7458 | 3.638 | 3.666 | 3.7868 | 3.7508 | 3.5347 | 3.6255 | 3.696 | 3.7417 |
| | 55 | 56 | 57 | 58 | 59 | 60 | 61 | 62 | 63 |
| P₂O₅ | 27.62 | 26 | 29 | 28 | 29 | 27 | 27 | 28 | 28 |
| TiO₂ | 20.95 | 31 | 13 | 34.38 | 22 | 34.35 | 22 | 22 | 22 |
| Nb₂O₅ | 32.38 | 27 | 42 | 28.32 | 33 | 26.44 | 33 | 33 | 33 |
| Li₂O | 1.9 | 2 | 2 | 2 | 1 | 2 | 2 | 2 | 1 |
| Na₂O | 0 | 0 | 0 | 0 | 0 | 0 | 0 | 0 | 0 |
| K₂O | 6.19 | 7 | 10.5 | 5.47 | 14 | 7.66 | 14 | 7.5 | 13 |
| CaO | 0 | 0 | 0 | 1.83 | 0 | 0 | 0 | 0 | 0 |
| BaO | 6.19 | 7 | 3.5 | 0 | 0 | 2.55 | 0 | 7.5 | 0 |
| ZnO | 4.76 | 0 | 0 | 0 | 1 | 0 | 2 | 0 | 3 |
| Ta₂O₅ | 0 | 0 | 0 | 0 | 0 | 0 | 0 | 0 | 0 |
| Al₂O₃ | 0 | 0 | 0 | 0 | 0 | 0 | 0 | 0 | 0 |
| Fe₂O₃ | 0 | 0 | 0 | 0 | 0 | 0 | 0 | 0 | 0 |
| P₂O₅/(TiO₂ + Nb₂O₅) | 0.518 | 0.448 | 0.527 | 0.447 | 0.527 | 0.444 | 0.491 | 0.509 | 0.509 |
| Na₂O + K₂O | 6.19 | 7 | 10.5 | 5.47 | 14 | 7.66 | 14 | 7.5 | 13 |
| K₂O − Na₂O | 6.19 | 7 | 10.5 | 5.47 | 14 | 7.66 | 14 | 7.5 | 13 |
| Pₙ | 1.9791 | 1.981 | 1.9994 | 2.0002 | 1.9547 | 1.983 | 1.963 | 1.9805 | 1.9634 |
| P_{d} | 3.751 | 3.707 | 3.6586 | 3.56 | 3.4832 | 3.5869 | 3.5237 | 3.72 | 3.532 |
| | 64 | 65 | 66 | 67 | 68 | 69 | 70 | 71 | 72 |
| P₂O₅ | 29 | 28 | 26 | 29 | 27 | 28 | 28 | 32 | 29 |
| TiO₂ | 30 | 22 | 35.68 | 22 | 34.97 | 20 | 22 | 30 | 33 |
| Nb₂O₅ | 21 | 33 | 26.82 | 33 | 24.93 | 35 | 33 | 21 | 21 |
| Li₂O | 2 | 1 | 2 | 1 | 2 | 2 | 1 | 2 | 2 |
| Na₂O | 0 | 0 | 0 | 0 | 0 | 0 | 1 | 0 | 0 |
| K₂O | 9 | 14 | 7.12 | 14 | 5.55 | 7.5 | 14 | 7.5 | 5 |
| CaO | 0 | 0 | 2.38 | 0 | 0 | 0 | 0 | 0 | 0 |
| BaO | 9 | 0 | 0 | 0 | 5.55 | 7.5 | 0 | 7.5 | 10 |
| ZnO | 0 | 2 | 0 | 1 | 0 | 0 | 1 | 0 | 0 |
| Ta₂O₅ | 0 | 0 | 0 | 0 | 0 | 0 | 0 | 0 | 0 |
| Al₂O₃ | 0 | 0 | 0 | 0 | 0 | 0 | 0 | 0 | 0 |
| Fe₂O₃ | 0 | 0 | 0 | 0 | 0 | 0 | 0 | 0 | 0 |
| P₂O₅/(TiO₂ + Nb₂O₅) | 0.569 | 0.509 | 0.416 | 0.527 | 0.451 | 0.509 | 0.509 | 0.627 | 0.537 |
| Na₂O + K₂O | 9 | 14 | 7.12 | 14 | 5.55 | 7.5 | 15 | 7.5 | 5 |
| K₂O − Na₂O | 9 | 14 | 7.12 | 14 | 5.55 | 7.5 | 13 | 7.5 | 5 |
| Pₙ | 1.9091 | 1.9597 | 1.9973 | 1.9547 | 1.9811 | 1.9881 | 1.9573 | 1.9002 | 1.9351 |
| P_{d} | 3.6065 | 3.5111 | 3.5656 | 3.4832 | 3.6602 | 3.737 | 3.4955 | 3.536 | 3.6792 |
| | 73 | 74 | 75 | 76 | 77 | 78 | 79 | 80 | 81 |
| P₂O₅ | 29 | 29 | 27 | 28 | 28.16 | 26 | 26 | 29 | 26 |
| TiO₂ | 30.43 | 33 | 22 | 22 | 32.04 | 36 | 33 | 33 | 33 |
| Nb₂O₅ | 28.66 | 21 | 33 | 33 | 20.39 | 21 | 21 | 21 | 24 |
| Li₂O | 2 | 2 | 1 | 2 | 4.85 | 2 | 2 | 2 | 2 |
| Na₂O | 0 | 0 | 0 | 0 | 0 | 0 | 0 | 0 | 0 |
| K₂O | 4.955 | 15 | 14 | 14 | 7.28 | 7.5 | 9 | 10 | 7.5 |
| CaO | 0 | 0 | 0 | 0 | 0 | 0 | 0 | 0 | 0 |
| BaO | 4.955 | 0 | 0 | 0 | 7.28 | 7.5 | 9 | 5 | 7.5 |
| ZnO | 0 | 0 | 3 | 1 | 0 | 0 | 0 | 0 | 0 |
| Ta₂O₅ | 0 | 0 | 0 | 0 | 0 | 0 | 0 | 0 | 0 |
| Al₂O₃ | 0 | 0 | 0 | 0 | 0 | 0 | 0 | 0 | 0 |
| Fe₂O₃ | 0 | 0 | 0 | 0 | 0 | 0 | 0 | 0 | 0 |
| P₂O₅/(TiO₂ + Nb₂O₅) | 0.491 | 0.537 | 0.491 | 0.509 | 0.537 | 0.456 | 0.481 | 0.537 | 0.456 |
| Na₂O + K₂O | 4.955 | 15 | 14 | 14 | 7.28 | 7.5 | 9 | 10 | 7.5 |
| K₂O − Na₂O | 4.955 | 15 | 14 | 14 | 7.28 | 7.5 | 9 | 10 | 7.5 |
| Pₙ | 1.9846 | 1.9002 | 1.9646 | 1.9581 | 1.9186 | 1.9525 | 1.9353 | 1.9177 | 1.9639 |
| P_{d} | 3.6474 | 3.3525 | 3.5391 | 3.4958 | 3.5857 | 3.659 | 3.668 | 3.5158 | 3.6845 |
| | 82 | 83 | 84 | 85 | 86 | 87 | 88 | 89 | 90 |
| P₂O₅ | 26 | 28 | 28 | 29 | 29 | 32 | 28 | 28 | 27 |
| TiO₂ | 22 | 22 | 22 | 33 | 25.2 | 33 | 22 | 24 | 28.81 |
| Nb₂O₅ | 33 | 33 | 33 | 24 | 33.18 | 21 | 33 | 31 | 30.28 |
| Li₂O | 2 | 1 | 2 | 2 | 2 | 2 | 2 | 2 | 2 |
| Na₂O | 0 | 0 | 0 | 0 | 0 | 0 | 0 | 0 | 0 |
| K₂O | 8.5 | 15 | 13 | 6 | 7.96 | 6 | 14 | 7.5 | 8.93 |
| CaO | 0 | 0 | 0 | 0 | 0 | 0 | 0 | 0 | 0 |
| BaO | 8.5 | 0 | 0 | 6 | 2.66 | 6 | 0 | 7.5 | 2.98 |
| ZnO | 0 | 1 | 2 | 0 | 0 | 0 | 1 | 0 | 0 |
| Ta₂O₅ | 0 | 0 | 0 | 0 | 0 | 0 | 0 | 0 | 0 |
| Al₂O₃ | 0 | 0 | 0 | 0 | 0 | 0 | 0 | 0 | 0 |
| Fe₂O₃ | 0 | 0 | 0 | 0 | 0 | 0 | 0 | 0 | 0 |
| P₂O₅/(TiO₂ + Nb₂O₅) | 0.473 | 0.509 | 0.509 | 0.509 | 0.497 | 0.593 | 0.509 | 0.509 | 0.457 |
| Na₂O + K₂O | 8.5 | 15 | 13 | 6 | 7.96 | 6 | 14 | 7.5 | 8.93 |
| K₂O − Na₂O | 8.5 | 15 | 13 | 6 | 7.96 | 6 | 14 | 7.5 | 8.93 |
| Pₙ | 1.9864 | 1.9559 | 1.9618 | 1.955 | 1.9884 | 1.9175 | 1.9581 | 1.9729 | 1.9863 |
| P_{d} | 3.767 | 3.4903 | 3.5166 | 3.614 | 3.6013 | 3.527 | 3.4958 | 3.703 | 3.6109 |
| | 91 | 92 | 93 | 94 | 95 | 96 | 97 | 98 | 99 |
| P₂O₅ | 29 | 27 | 29 | 28 | 28 | 27 | 27.98 | 26 | 28 |
| TiO₂ | 33 | 22 | 30 | 22 | 22 | 33.98 | 21.99 | 30 | 22 |
| Nb₂O₅ | 21 | 33 | 24 | 33 | 33 | 26.7 | 30.98 | 29 | 33 |
| Li₂O | 2 | 1 | 2 | 2 | 1 | 2 | 2 | 2 | 2 |
| Na₂O | 0 | 0 | 0 | 0 | 2 | 0 | 0.0026 | 0 | 0 |
| K₂O | 7.5 | 15 | 7.5 | 15 | 14 | 4.16 | 8.49 | 6.5 | 11.25 |
| CaO | 0 | 0 | 0 | 0 | 0 | 6.16 | 0 | 0 | 0 |
| BaO | 7.5 | 0 | 7.5 | 0 | 0 | 0 | 8.49 | 6.5 | 3.75 |
| ZnO | 0 | 2 | 0 | 0 | 0 | 0 | 0 | 0 | 0 |
| Ta₂O₅ | 0 | 0 | 0 | 0 | 0 | 0 | 0.0285 | 0 | 0 |
| Al₂O₃ | 0 | 0 | 0 | 0 | 0 | 0 | 0.0396 | 0 | 0 |
| Fe₂O₃ | 0 | 0 | 0 | 0 | 0 | 0 | 0 | 0 | 0 |
| P₂O₅/(TiO₂ + Nb₂O₅) | 0.537 | 0.491 | 0.537 | 0.509 | 0.509 | 0.445 | 0.528 | 0.441 | 0.509 |
| Na₂O + K₂O | 7.5 | 15 | 7.5 | 15 | 16 | 4.16 | 8.4926 | 6.5 | 11.25 |
| K₂O − Na₂O | 7.5 | 15 | 7.5 | 15 | 12 | 4.16 | 8.4874 | 6.5 | 11.25 |
| Pₙ | 1.9264 | 1.9609 | 1.9377 | 1.9543 | 1.9549 | 1.9941 | 1.9614 | 1.9943 | 1.9674 |
| P_{d} | 3.5975 | 3.5183 | 3.623 | 3.4749 | 3.4798 | 3.5787 | 3.7099 | 3.721 | 3.5975 |
| | 100 | 101 | 102 | 103 | 104 | 105 | 106 | 107 | 108 |
| P₂O₅ | 32 | 29 | 29 | 29 | 26 | 26 | 29 | 29 | 28 |
| TiO₂ | 16 | 38.4 | 30.53 | 32.9 | 16 | 33 | 30 | 30 | 22 |
| Nb₂O₅ | 39 | 24 | 29.54 | 27.4 | 42 | 26 | 26 | 29 | 33 |
| Li₂O | 2 | 2 | 2 | 2 | 2 | 2 | 2 | 1.6 | 1 |
| Na₂O | 0 | 0 | 0 | 0 | 0 | 0 | 0 | 0 | 0 |
| K₂O | 8.6 | 2.3 | 2.23 | 3.35 | 10.5 | 6.5 | 8.6 | 5.2 | 14 |
| CaO | 0 | 0 | 0 | 0 | 0 | 0 | 0 | 0 | 0 |
| BaO | 2.4 | 4.3 | 6.7 | 5.35 | 3.5 | 6.5 | 4.4 | 5.2 | 0 |
| ZnO | 0 | 0 | 0 | 0 | 0 | 0 | 0 | 0 | 2 |
| Ta₂O₅ | 0 | 0 | 0 | 0 | 0 | 0 | 0 | 0 | 0 |
| Al₂O₃ | 0 | 0 | 0 | 0 | 0 | 0 | 0 | 0 | 0 |
| Fe₂O₃ | 0 | 0 | 0 | 0 | 0 | 0 | 0 | 0 | 0 |
| P₂O₅/(TiO₂ + Nb₂O₅) | 0.582 | 0.465 | 0.483 | 0.481 | 0.448 | 0.441 | 0.518 | 0.492 | 0.509 |
| Na₂O + K₂O | 8.6 | 2.3 | 2.23 | 3.35 | 10.5 | 6.5 | 8.6 | 5.2 | 14 |
| K₂O − Na₂O | 8.6 | 2.3 | 2.23 | 3.35 | 10.5 | 6.5 | 8.6 | 5.2 | 14 |
| Pₙ | 1.9805 | 1.9895 | 2.0014 | 1.9903 | 2.0255 | 1.9829 | 1.9495 | 1.9853 | 1.9597 |
| P_{d} | 3.5757 | 3.6305 | 3.7249 | 3.6657 | 3.7201 | 3.6955 | 3.5654 | 3.6549 | 3.5111 |
| | 109 | 110 | 111 | 112 | 113 | 114 | 115 | 116 | 117 |
| P₂O₅ | 29 | 29 | 29 | 28 | 28 | 29 | 26 | 25.98 | 27.96 |
| TiO₂ | 22 | 33 | 19 | 33.33 | 22 | 30 | 19 | 29.98 | 30.96 |
| Nb₂O₅ | 34 | 26 | 36 | 27.45 | 31 | 26 | 39 | 25.98 | 24.97 |
| Li₂O | 2 | 1.6 | 2 | 2 | 2 | 2 | 2 | 2.4 | 2 |
| Na₂O | 0 | 0 | 0 | 0 | 0 | 0 | 0 | 0.0048 | 0.0048 |
| K₂O | 6.5 | 5.2 | 10.5 | 3.61 | 8.5 | 10.8 | 10.5 | 7.79 | 6.99 |
| CaO | 0 | 0 | 0 | 5.61 | 0 | 0 | 0 | 0 | 0 |
| BaO | 6.5 | 5.2 | 3.5 | 0 | 8.5 | 2.2 | 3.5 | 7.79 | 6.99 |
| ZnO | 0 | 0 | 0 | 0 | 0 | 0 | 0 | 0 | 0 |
| Ta₂O₅ | 0 | 0 | 0 | 0 | 0 | 0 | 0 | 0 | 0.0229 |
| Al₂O₃ | 0 | 0 | 0 | 0 | 0 | 0 | 0 | 0.0662 | 0.0993 |
| Fe₂O₃ | 0 | 0 | 0 | 0 | 0 | 0 | 0 | 0 | 0 |
| P₂O₅/(TiO₂ + Nb₂O₅) | 0.518 | 0.492 | 0.527 | 0.461 | 0.528 | 0.518 | 0.448 | 0.464 | 0.5 |
| Na₂O + K₂O | 6.5 | 5.2 | 10.5 | 3.61 | 8.5 | 10.8 | 10.5 | 7.7948 | 6.9948 |
| K₂O − Na₂O | 6.5 | 5.2 | 10.5 | 3.61 | 8.5 | 10.8 | 10.5 | 7.7852 | 6.9852 |
| Pₙ | 1.9871 | 1.9739 | 1.9767 | 1.9947 | 1.9614 | 1.9418 | 2.0142 | 1.9656 | 1.9557 |
| P_{d} | 3.702 | 3.6294 | 3.6076 | 3.5726 | 3.709 | 3.4935 | 3.6946 | 3.6993 | 3.649 |
| | 118 | 119 | 120 | 121 | 122 | 123 | 124 | 125 | 126 |
| P₂O₅ | 32 | 29 | 29 | 27 | 27.98 | 29 | 29 | 27 | 29 |
| TiO₂ | 16 | 38.4 | 25.6 | 24 | 21.99 | 30 | 30 | 22 | 36 |
| Nb₂O₅ | 36 | 24 | 32 | 34 | 32.97 | 26 | 23 | 36 | 21 |
| Li₂O | 2 | 2 | 2 | 2 | 2 | 2 | 2.4 | 2 | 2 |
| Na₂O | 0 | 0 | 0 | 0 | 0.0026 | 0 | 0 | 0 | 0 |
| K₂O | 10.5 | 2.3 | 4.7 | 6.5 | 14.99 | 6.5 | 7.8 | 6.5 | 6 |
| CaO | 0 | 2.15 | 3.35 | 0 | 0 | 0 | 0 | 0 | 0 |
| BaO | 3.5 | 2.15 | 3.35 | 6.5 | 0 | 6.5 | 7.8 | 6.5 | 6 |
| ZnO | 0 | 0 | 0 | 0 | 0 | 0 | 0 | 0 | 0 |
| Ta₂O₅ | 0 | 0 | 0 | 0 | 0.0304 | 0 | 0 | 0 | 0 |
| Al₂O₃ | 0 | 0 | 0 | 0 | 0.047 | 0 | 0 | 0 | 0 |
| Fe₂O₃ | 0 | 0 | 0 | 0 | 0 | 0 | 0 | 0 | 0 |
| P₂O₅/(TiO₂ + Nb₂O₅) | 0.615 | 0.465 | 0.503 | 0.466 | 0.509 | 0.518 | 0.547 | 0.466 | 0.509 |
| Na₂O + K₂O | 10.5 | 2.3 | 4.7 | 6.5 | 14.9926 | 6.5 | 7.8 | 6.5 | 6 |
| K₂O − Na₂O | 10.5 | 2.3 | 4.7 | 6.5 | 14.9874 | 6.5 | 7.8 | 6.5 | 6 |
| Pₙ | 1.9505 | 1.9889 | 1.9913 | 2.0045 | 1.9543 | 1.9568 | 1.9283 | 2.0121 | 1.9436 |
| P_{d} | 3.5461 | 3.5863 | 3.6439 | 3.743 | 3.4761 | 3.634 | 3.6131 | 3.76 | 3.5885 |
| | 127 | 128 | 129 | 130 | 131 | 132 | 133 | 134 | 135 |
| P₂O₅ | 29 | 29 | 28.96 | 29 | 29 | 29 | 29 | 29 | 26 |
| TiO₂ | 27 | 30 | 32.96 | 19 | 25.6 | 27 | 32.9 | 30 | 16 |
| Nb₂O₅ | 26 | 26 | 23.97 | 39 | 32 | 29 | 27.4 | 26 | 39 |
| Li₂O | 2.4 | 2 | 2 | 2 | 2 | 2 | 2 | 2 | 2 |
| Na₂O | 0 | 0 | 0.0047 | 0 | 0 | 0 | 0 | 0 | 0 |
| K₂O | 7.8 | 3.3 | 5.99 | 8.6 | 4.7 | 6.5 | 3.35 | 13 | 12.7 |
| CaO | 0 | 0 | 0 | 0 | 0 | 0 | 2.675 | 0 | 0 |
| BaO | 7.8 | 9.7 | 5.99 | 2.4 | 6.7 | 6.5 | 2.675 | 0 | 4.3 |
| ZnO | 0 | 0 | 0 | 0 | 0 | 0 | 0 | 0 | 0 |
| Ta₂O₅ | 0 | 0 | 0 | 0 | 0 | 0 | 0 | 0 | 0 |
| Al₂O₃ | 0 | 0 | 0.12 | 0 | 0 | 0 | 0 | 0 | 0 |
| Fe₂O₃ | 0 | 0 | 0 | 0 | 0 | 0 | 0 | 0 | 0 |
| P₂O₅/(TiO₂ + Nb₂O₅) | 0.547 | 0.518 | 0.509 | 0.5 | 0.503 | 0.518 | 0.481 | 0.518 | 0.473 |
| Na₂O + K₂O | 7.8 | 3.3 | 5.9947 | 8.6 | 4.7 | 6.5 | 3.35 | 13 | 12.7 |
| K₂O − Na₂O | 7.8 | 3.3 | 5.9853 | 8.6 | 4.7 | 6.5 | 3.35 | 13 | 12.7 |
| Pₙ | 1.9397 | 1.968 | 1.9545 | 2.0067 | 1.9922 | 1.9682 | 1.9896 | 1.9341 | 1.9945 |
| P_{d} | 3.6386 | 3.7386 | 3.6126 | 3.6372 | 3.7129 | 3.6595 | 3.6106 | 3.4217 | 3.6807 |
| | 136 | 137 | 138 | 139 | 140 | 141 | 142 | 143 | 144 |
| P₂O₅ | 27.98 | 32 | 30 | 27.98 | 29 | 28.96 | 26 | 30 | 27.95 |
| TiO₂ | 21.99 | 13 | 22 | 19.99 | 33 | 35.96 | 30 | 20 | 21.96 |
| Nb₂O₅ | 32.97 | 39 | 31 | 32.97 | 23 | 20.97 | 26 | 33 | 32.94 |
| Li₂O | 2 | 2 | 2 | 2 | 2 | 2 | 2.4 | 2 | 1 |
| Na₂O | 0.0026 | 0 | 0 | 0.0027 | 0 | 0.0046 | 0 | 0 | 0.0775 |
| K₂O | 11.24 | 10.5 | 7.5 | 8.49 | 6.5 | 5.99 | 7.8 | 7.5 | 13.97 |
| CaO | 0 | 0 | 0 | 0 | 0 | 0 | 0 | 0 | 0 |
| BaO | 3.75 | 3.5 | 7.5 | 8.49 | 6.5 | 5.99 | 7.8 | 7.5 | 0 |
| ZnO | 0 | 0 | 0 | 0 | 0 | 0 | 0 | 0 | 2 |
| Ta₂O₅ | 0.0304 | 0 | 0 | 0.0303 | 0 | 0 | 0 | 0 | 0 |
| Al₂O₃ | 0.0477 | 0 | 0 | 0.0405 | 0 | 0.12 | 0 | 0 | 0.0973 |
| Fe₂O₃ | 0 | 0 | 0 | 0 | 0 | 0 | 0 | 0 | 0.009 |
| P₂O₅/(TiO₂ + Nb₂O₅) | 0.509 | 0.615 | 0.566 | 0.528 | 0.518 | 0.509 | 0.464 | 0.566 | 0.509 |
| Na₂O + K₂O | 11.2426 | 10.5 | 7.5 | 8.4927 | 6.5 | 5.9946 | 7.8 | 7.5 | 14.0475 |
| K₂O − Na₂O | 11.2374 | 10.5 | 7.5 | 8.4873 | 6.5 | 5.9854 | 7.8 | 7.5 | 13.8925 |
| Pₙ | 1.9674 | 1.9619 | 1.9555 | 1.969 | 1.9454 | 1.9432 | 1.9658 | 1.9631 | 1.959 |
| P_{d} | 3.5985 | 3.5716 | 3.662 | 3.727 | 3.6085 | 3.5871 | 3.7001 | 3.679 | 3.5099 |

| | 145 | 146 | 147 | 148 | 149 |
|---|---|---|---|---|---|
| P₂O₅ | 29 | 30 | 28 | 27.96 | 27 |
| TiO₂ | 16 | 22 | 22 | 28.97 | 22 |
| Nb₂O₅ | 39 | 33 | 35 | 26.96 | 34 |
| Li₂O | 2 | 2 | 2 | 2 | 2.26 |
| Na₂O | 0 | 0 | 0 | 0.0049 | 0 |
| K₂O | 10.5 | 6.5 | 6.5 | 6.99 | 7.37 |
| CaO | 0 | 0 | 0 | 0 | 0 |
| BaO | 3.5 | 6.5 | 6.5 | 6.99 | 7.37 |
| ZnO | 0 | 0 | 0 | 0 | 0 |
| Ta₂O₅ | 0 | 0 | 0 | 0.0249 | 0 |
| Al₂O₃ | 0 | 0 | 0 | 0.0988 | 0 |
| Fe₂O₃ | 0 | 0 | 0 | 0 | 0 |
| P₂O₅/(TiO₂ + Nb₂O₅) | 0.527 | 0.545 | 0.491 | 0.5 | 0.482 |
| Na₂O + K₂O | 10.5 | 6.5 | 6.5 | 6.9949 | 7.37 |
| K₂O − Na₂O | 10.5 | 6.5 | 6.5 | 6.9851 | 7.37 |
| Pₙ | 1.988 | 1.9746 | 1.9996 | 1.9633 | 1.9931 |
| P_{d} | 3.6331 | 3.673 | 3.731 | 3.6661 | 3.7461 |

The following non-limiting aspects are encompassed by the present disclosure. To the extent not already described, any one of the features of the first through the sixty-ninth aspect may be combined in part or in whole with features of any one or more of the other aspects of the present disclosure to form additional aspects, even if such a combination is not explicitly described.

According to a first aspect, the glass comprises a plurality of components, the glass having a composition of the components comprising greater than or equal to 25.5 mol. % P₂O₅, greater than or equal to 20.0 mol. % Nb₂O₅, greater than or equal to 0.5 mol. % and less than or equal to 40.0 mol. % TiO₂, greater than or equal to 0.1 mol. % and less than or equal to 8.0 mol. % Li₂O, a sum of Na₂O+K₂O is greater than or equal to 1.0 mol. % and less than or equal to 30.0 mol. %, a sum of FeO+Fe₂O₃ is greater than or equal to 0.000 mol. % and less than or equal to 0.020 mol. % and may optionally contain one or more components selected from Al₂O₃, B₂O₃, BaO, Bi₂O₃, CaO, CdO, Cs₂O, GeO₂, La₂O₃, MgO, MoO₃, PbO, SiO₂, SrO, Ta₂O₅, TeO₂, WO₃, ZrO₂, Ga₂O₃ and ZnO, wherein the composition of the components is substantially free of V₂O₅, and wherein the composition of the components satisfies the conditions: P₂O₅/(TiO₂+Nb₂O₅) [mol. %]≥0.30 and K₂O−Na₂O [mol. %]≥0.000, and the glass satisfies the conditions: Pₙ>1.9000 and P_{d}<3.80, where Pₙ is a refractive index parameter, calculated from the glass composition in terms of mol. % of the components according to the Formula (I):

$${P}_{n} = 1.82063 - 0.0023121 * {AlO}_{3} - 0.003381 * {B}_{2} {O}_{3} - 0.00024425 * BaO + 0.0088252 * {Bi}_{2} {O}_{3} - 0.00051393 * CaO + 0.00083458 * CdO - 0.0021789 * {Cs}_{2} O - 0.0015444 * {GeO}_{2} - 0.0037344 * {K}_{2} O + 0.0022272 * {La}_{2} {O}_{3} - 0.0016171 * {Li}_{2} O - 0.0015687 * MgO + 0.0026917 * {MoO}_{3} - 0.0023954 * {Na}_{2} O + 0.007544 * {Nb}_{2} {O}_{5} - 0.0049543 * {P}_{2} {O}_{5} + 0.0033051 * PbO - 0.0029543 * {SiO}_{2} - 0.00038966 * SrO + 0.0069184 * {Ta}_{2} {O}_{5} + 0.0025768 * {TeO}_{2} + 0.0037599 * {TiO}_{2} + 0.0041441 * {V}_{2} {O}_{5} + 0.0032619 * {WO}_{3} + 0.0024821 * {ZrO}_{2} , \qquad ( I )$$

P_{d} is a density parameter, calculated from the glass composition in terms of mol. % of the components according to the Formula (II):

$${P}_{d} = 3.98457 - 0.015773 * {Al}_{2} {O}_{3} - 0.014501 * {B}_{2} {O}_{3} + 0.019328 * BaO + 0.060758 * {Bi}_{2} {O}_{3} - 0.0012685 * CaO + 0.023111 * CdO + 0.0053184 * {Cs}_{2} O + 0.011488 * {Ga}_{2} {O}_{3} - 0.0015416 * {GeO}_{2} - 0.013342 * {K}_{2} O + 0.058319 * {La}_{2} {O}_{3} - 0.007918 * {Li}_{2} O - 0.0024123 * MgO - 0.0024413 * {MoO}_{3} - 0.0082226 * {Na}_{2} O + 0.0084961 * {Nb}_{2} {O}_{5} - 0.020501 * {P}_{2} {O}_{5} + 0.038898 * PbO - 0.01272 * {SiO}_{2} + 0.013948 * SrO + 0.047924 * {Ta}_{2} {O}_{5} + 0.011248 * {YeO}_{2} - 0.0092491 * {V}_{2} {O}_{5} + 0.028913 * {WO}_{3} + 0.0074702 * ZnO + 0.0096721 * {ZrO}_{2} , \qquad ( II )$$

where an asterisk (*) means multiplication.

According to a second aspect, the glass of the first aspect, wherein the glass has a refractive index at 587.56 nm, n_{d} that is greater than or equal to 1.9000 and a density at room temperature, d_{RT} that is less than or equal to 3.80 g/cm³.

According to a third aspect, the glass of any one of aspects 1-2, wherein the composition of the components comprises greater than or equal to 26.5 mol. % P₂O₅.

According to a fourth aspect, the glass of the third aspect, wherein the composition of the components comprises greater than or equal to 27.5 mol. % P₂O₅.

According to a fifth aspect, the glass of any one of aspects 1-4, wherein the composition of the components comprises less than or equal to 32.0 mol. % P₂O₅.

According to a sixth aspect, the glass of the fifth aspect, wherein the composition of the components comprises less than or equal to 30.0 mol. % P₂O₅.

According to a seventh aspect, the glass of any one of aspects 1-6, wherein the composition of the components comprises greater than or equal to 13.0 mol. % TiO₂.

According to an eighth aspect, the glass of the seventh aspect, wherein the composition of the components comprises greater than or equal to 17.0 mol. % TiO₂.

According to a ninth aspect, the glass of the eighth aspect, wherein the composition of the components comprises greater than or equal to 21.0 mol. % TiO₂.

According to a tenth aspect, the glass of the ninth aspect, wherein the composition of the components comprises greater than or equal to 25.0 mol. % TiO₂.

According to an eleventh aspect, the glass of the tenth aspect, wherein the composition of the components comprises greater than or equal to 29.0 mol. % TiO₂.

According to a twelfth aspect, the glass of any one of aspects 1-11, wherein the composition of the components comprises less than or equal to 36.0 mol. % TiO₂.

According to a thirteenth aspect, the glass of the twelfth aspect, wherein the composition of the components comprises greater than or equal to 32.0 mol. % TiO₂.

According to a fourteenth aspect, the glass of the thirteenth aspect, wherein the composition of the components comprises less than or equal to 24.0 mol. % TiO₂.

According to a fifteenth aspect, the glass of the fourteenth aspect, wherein the composition of the components comprises less than or equal to 22.5 mol. % TiO₂.

According to a sixteenth aspect, the glass of the fifteenth aspect, wherein the composition of the components comprises less than or equal to 20.0 mol. % TiO₂.

According to a seventeenth aspect, the glass of any one of aspects 1-16, wherein the composition of the components comprises greater than or equal to 18.0 mol. % and less than or equal to 23.5 mol. % TiO₂.

According to a eighteenth aspect, the glass of any one of aspects 1-17, wherein the composition of the components comprises greater than or equal to 24.0 mol. % Nb₂O₅.

According to a nineteenth aspect, the glass of the eighteenth aspect, wherein the composition of the components comprises greater than or equal to 28.0 mol. % Nb₂O₅.

According to a twentieth aspect, the glass of the nineteenth aspect, wherein the composition of the components comprises greater than or equal to 30.0 mol. % Nb₂O₅.

According to a twenty-first aspect, the glass of the twentieth aspect, wherein the composition of the components comprises greater than or equal to 32.0 mol. % Nb₂O₅.

According to a twenty-second aspect, the glass of any one of aspects 1-21, wherein the composition of the components comprises less than or equal to 44.0 mol. % Nb₂O₅.

According to a twenty-third aspect, the glass of the twenty-second aspect, wherein the composition of the components comprises less than or equal to 40.0 mol. % Nb₂O₅.

According to a twenty-fourth aspect, the glass of the twenty-third aspect, wherein the composition of the components comprises less than or equal to 36.0 mol. % Nb₂O₅.

According to a twenty-fifth aspect, the glass of the twenty-fourth aspect, wherein the composition of the components comprises less than or equal to 35.0 mol. % Nb₂O₅.

According to a twenty-sixth aspect, the glass of the eighteenth aspect, wherein the composition of the components comprises greater than or equal to 28.0 mol. % and less than or equal to 35.0 mol. % Nb₂O₅.

According to a twenty-seventh aspect, the glass of any one of aspects 1-26, wherein the composition of the components comprises a sum of Li₂O+Na₂O+K₂O greater than or equal to 10.0 mol. %.

According to a twenty-eighth aspect, the glass of the twenty-seventh aspect, wherein the composition of the components comprises a sum of Li₂O+Na₂O+K₂O greater than or equal to 15.0 mol. %.

According to a twenty-ninth aspect, the glass of any one of aspects 1-28, wherein the composition of the components comprises a sum of Li₂O+Na₂O+K₂O less than or equal to 25.0 mol. %.

According to a thirtieth aspect, the glass of the twenty-ninth aspect, wherein the composition of the components comprises a sum of Li₂O+Na₂O+K₂O less than or equal to 20.0 mol. %.

According to a thirty-first aspect, the glass of the twenty-seventh aspect, wherein the composition of the components comprises a sum of Li₂O+Na₂O+K₂O greater than or equal to 15.0 mol. % and less than or equal to 20.0 mol. %.

According to a thirty-second aspect, the glass of any one of aspects 1-31, wherein the composition of the components comprises two or more of Li₂O, Na₂O and K₂O.

According to a thirty-third aspect, the glass of any one of aspects 1-32, wherein the composition of the components comprises greater than or equal to 5.0 mol. % K₂O.

According to a thirty-fourth aspect, the glass of the thirty-third aspect, wherein the composition of the components comprises greater than or equal to 10.0 mol. % K₂O.

According to a thirty-fifth aspect, the glass of any one of aspects 1-34, wherein the composition of the components comprises greater than or equal to 1.5 mol. % Li₂O.

According to a thirty-sixth aspect, the glass of any one of aspects 1-35, wherein the composition of the components comprises less than or equal to 5.0 mol. % Li₂O.

According to a thirty-seventh aspect, the glass of the thirty-sixth aspect, wherein the composition of the components comprises less than or equal to 3.0 mol. % Li₂O.

According to a thirty-eighth aspect, the glass of any one of aspects 1-37, wherein the composition of the components comprises greater than or equal to 1.5 mol. % and less than or equal to 3.0 mol. % Li₂O.

According to a thirty-ninth aspect, the glass of any one of aspects 1-38, wherein the composition of the components comprises greater than or equal to 0.0 mol. % and less than or equal to 2.0 mol. % Na₂O.

According to a fortieth aspect, the glass of the thirty-ninth aspect, wherein the composition of the components comprises greater than or equal to 0.0 mol. % and less than or equal to 0.5 mol. % Na₂O.

According to a forty-first aspect, the glass of the fortieth aspect, wherein the composition of the components is substantially free of Na₂O.

According to a forty-second aspect, the glass of any one of aspects 1-41, wherein the composition of the components satisfies the conditions: K₂O−Na₂O [mol. %]≥0.50 and Li₂O−Na₂O [mol. %]≥0.50.

According to a forty-third aspect, the glass of the forty-second aspect, wherein the composition of the components satisfies the conditions: K₂O−Na₂O [mol. %]≥1.50 and Li₂O−Na₂O [mol. %]≥1.00.

According to a forty-fourth aspect, the glass of the forty-third aspect, wherein the composition of the components satisfies the conditions: K₂O−Na₂0 [mol. %]≥3.00 and Li₂O−Na₂O [mol. %]≥1.50.

According to a forty-fifth aspect, the glass of any one of aspects 1-44, wherein the composition of the components comprises a sum of CaO+SrO+BaO greater than or equal to 3.0 mol. %.

According to a forty-sixth aspect, the glass of the forty-fifth aspect, wherein the composition of the components comprises a sum of CaO+SrO+BaO greater than or equal to 6.0 mol. %.

According to a forty-seventh aspect, the glass of any one of aspects 1-45, wherein the composition of the components comprises a sum of CaO+SrO+BaO less than or equal to 12.0 mol. %.

According to a forty-eighth aspect, the glass of the forty-seventh aspect, wherein the composition of the components comprises a sum of CaO+SrO+BaO less than or equal to 9.0 mol. %.

According to a forty-ninth aspect, the glass of the forty-eighth aspect, wherein the composition of the components comprises a sum of CaO+SrO+BaO greater than or equal to 6.0 mol. % and less than or equal to 9.0 mol. %.

According to a fiftieth aspect, the glass of any one of aspects 1-49, wherein the composition of the components comprises greater than or equal to 25.5 mol. % and less than or equal to 29.0 mol. % P₂O₅, greater than or equal to 20.0 mol. % and less than or equal to 35.0 mol. % Nb₂O₅, greater than or equal to 10.0 mol. % and less than or equal to 40.0 mol. % TiO₂, greater than or equal to 5.0 mol. % and less than or equal to 15.0 mol. % K₂O, greater than or equal to 1.0 mol. % and less than or equal to 2.5 mol. % Li₂O, greater than or equal to 0.0 mol. % and less than or equal to 10.0 mol. % BaO and greater than or equal to 0.0 mol. % and less than or equal to 2.0 mol. % ZnO.

According to a fifty-first aspect, the glass of any one of aspects 1-50, wherein the composition of the components comprises one or more of the following: greater than or equal to 26.2 mol. % and less than or equal to 29.0 mol. % P₂O₅, greater than or equal to 22.0 mol. % and less than or equal to 33.0 mol. % Nb₂O₅, greater than or equal to 21.5 mol. % and less than or equal to 34.5 mol. % TiO₂, greater than or equal to 6.0 mol. % and less than or equal to 14.0 mol. % K₂O, greater than or equal to 1.1 mol. % and less than or equal to 2.3 mol. % Li₂O, greater than or equal to 0.0 mol. % and less than or equal to 8.5 mol. % BaO and greater than or equal to 0.0 mol. % and less than or equal to 1.8 mol. % ZnO.

According to a fifty-second aspect, the glass of any one of aspects 1-52, wherein the composition of the components comprises greater than or equal to 26.5 mol. % and less than or equal to 28.4 mol. % P₂O₅, greater than or equal to 23.0 mol. % and less than or equal to 30.0 mol. % Nb₂O₅, greater than or equal to 21.5 mol. % and less than or equal to 33.0 mol. % TiO₂, greater than or equal to 6.75 mol. % and less than or equal to 13.25 mol. % K₂O, greater than or equal to 1.50 mol. % and less than or equal to 7.75 mol. % BaO, greater than or equal to 1.25 mol. % and less than or equal to 2.15 mol. % Li₂O and greater than or equal to 0.0 mol. % and less than or equal to 1.6 mol. % ZnO.

According to a fifty-third aspect, the glass of the fiftieth aspect, wherein the composition of the components comprises greater than or equal to 26.0 mol. % and less than or equal to 32.0 mol. % P₂O₅, greater than or equal to 20.0 mol. % and less than or equal to 42.0 mol. % Nb₂O₅, greater than or equal to 13.0 mol. % and less than or equal to 38.4 mol. % TiO₂, greater than or equal to 2.00 mol. % and less than or equal to 15.0 mol. % K₂O, greater than or equal to 0.00 mol. % and less than or equal to 11.00 mol. % BaO, greater than or equal to 1.00 mol. % and less than or equal to 5.00 mol. % Li₂O and greater than or equal to 0.0 mol. % and less than or equal to 2.0 mol. % Na₂O.

According to a fifty-fourth aspect, the glass of any one of aspects 1-53, wherein the composition of the components comprises greater than or equal to 0.000 mol. % and less than or equal to 0.020 mol. % Cr₂O₃, and wherein the composition of the components is substantially free of B₂O₃, substantially free of Na₂O, substantially free of SiO₂, and substantially free of ZnO.

According to a fifty-fifth aspect, the glass of any one of aspects 1-54, wherein the composition of the components satisfies the condition: P₂O₅/(TiO₂+Nb₂O₅) [mol. %]≥0.45.

According to a fifty-sixth aspect, the glass of the fifty-fifth aspect, wherein the composition of the components satisfies the condition: P₂O₅/(TiO₂+Nb₂O₅) [mol. %]≥0.47.

According to a fifty-seventh aspect, the glass of the fifty-sixth aspect, wherein the composition of the components satisfies the condition: P₂O₅/(TiO₂+Nb₂O₅) [mol. %]≥0.49.

According to a fifty-eighth aspect, the glass of the fifty-seventh aspect, wherein the composition of the components satisfies the condition: P₂O₅/(TiO₂+Nb₂O₅) [mol. %]≥0.51.

According to a fifty-ninth aspect, the glass of the fifty-eighth aspect, wherein the composition of the components satisfies the condition: P₂O₅/(TiO₂+Nb₂O₅) [mol. %]≥0.53.

According to a sixtieth aspect, the glass of any one of aspects 1-59, wherein the glass satisfies the condition: Pₙ>1.9300.

According to a sixty-first aspect, the glass of any one of aspects 1-60, wherein the glass has a refractive index at 587.56 nm, n_{d} that is greater than or equal to 1.9300.

According to a sixty-second aspect, the glass of the sixty-first aspect, wherein the glass has a refractive index at 587.56 nm, n_{d} that is greater than or equal to 1.9550.

According to a sixty-third aspect, the glass of any one of aspects 1-62, wherein the glass satisfies the condition: P_{d}<3.70.

According to a sixty-fourth aspect, the glass of the sixty-third aspect, wherein the glass satisfies the condition: P_{d}<3.60.

According to a sixty-fifth aspect, the glass of the sixty-fourth aspect, wherein the glass satisfies the condition: P_{d}<3.50.

According to a sixty-sixth aspect, the glass of any one of aspects 1-65, wherein the glass has a density at room temperature, d_{RT} that is less than or equal to 3.70 g/cm³.

According to a sixty-seventh aspect, the glass of the sixty-sixth aspect, wherein the glass has a density at room temperature, d_{RT} that is less than or equal to 3.60 g/cm³.

According to a sixty-eighth aspect, the glass of the sixty-seventh aspect, wherein the glass has a density at room temperature, d_{RT} that is less than or equal to 3.50 g/cm³.

According to a sixty-ninth aspect, the glass of any one of aspects 1-68, wherein the glass satisfies the condition: P_{ref}>0.24, where P_{ref} is a refraction parameter, calculated from the glass composition in terms of mol. % of the components according to the Formula (IV):

$${P}_{ref} = 0.223637 + 0.0010703 * {Nb}_{2} {O}_{5} - 0.00041688 * {P}_{2} {O}_{5} + 0.00088482 * {TiO}_{2} + 0.000054956 * CaO - 0.00029243 * {K}_{2} O - 0.0008347 * BaO - 0.00023739 * {Na}_{2} O + 0.000082792 * {Li}_{2} O - 0.0012487 * {WO}_{3} - 0.00042393 * ZnO - 0.00059152 * SrO - 0.00018266 * MgO - 0.0014091 * {Bi}_{2} {O}_{3} - 0.0014895 * {Ta}_{2} {O}_{5} - 0.00021842 * {SiO}_{2} - 0.00024788 * {ZrO}_{2} - 0.00014801 * {B}_{2} {O}_{3} - 0.000060848 * {TeO}_{2} - 0.00085564 * PbO - 0.00042429 * {GeO}_{2} - 0.0015439 * {Tl}_{2} O - 0.0012936 * {Ag}_{2} O - 0.00089356 * {Cu}_{2} O - 0.00039278 * CuO + 0.00017895 * {As}_{2} {O}_{3} - 0.00011802 * {Sb}_{2} {O}_{3} . \qquad ( IV )$$

where an asterisk (*) means multiplication.

According to a seventieth aspect, the glass of any one of aspects 1-69, wherein the glass has a refractive index to density ratio (“refraction”), (n_{d}−1)/d_{RT} that is greater than or equal to 0.24.

According to a seventy-first aspect, the glass of the seventieth aspect, wherein the glass has a refractive index to density ratio (“refraction”), (n_{d}−1)/d_{RT} that is greater than or equal to 0.25.

According to a seventy-second aspect, the glass of any one of aspects 1-71, wherein the glass satisfies the condition: P_{ν}<18.50, where P_{ν} is a dispersion parameter, calculated from the glass composition in terms of mol. % of the components according to the Formula (III):

$${P}_{v} = exp ( 2.11 + 0.0438 * ( exp ( 3.2598 + 0.0072248 * {Al}_{2} {O}_{3} + 0.0055494 * {B}_{2} {O}_{3} + 0.0024164 * BaO - 0.00849 * {Bi}_{2} {O}_{3} + 0.0029812 * CaO + 0.0092768 * CdO + 0.0099824 * {Ga}_{2} {O}_{3} - 0.0038579 * {GeO}_{2} + 0.0028062 * {K}_{2} O + 0.0031951 * {Li}_{2} O + 0.0027011 * MgO + 0.007976 * {MoO}_{3} + 0.0028705 * {Na}_{2} O - 0.013374 * {Nb}_{2} {O}_{5} + 0.0072007 * {P}_{2} {O}_{5} - 0.0049796 * PbO + 0.0032241 * {SiO}_{2} + 0.0050024 * SrO - 0.002136 * {Ta}_{2} {O}_{5} - 0.0032329 * {TeO}_{2} - 0.009788 * {TiO}_{2} + 0.0074782 * {V}_{2} {O}_{5} - 0.00057095 * {WO}_{3} + 0.0032826 * ZnO + 0.009302 * {ZrO}_{2} ) ) ) , \qquad ( III )$$

where an asterisk (*) means multiplication.

According to a seventy-third aspect, the glass of any one of aspects 1-72, wherein the glass has an Abbe number, ν_{d} that is less than or equal to 18.50.

According to a seventy-fourth aspect, the glass of the seventy-third aspect, wherein the glass has an Abbe number, ν_{d} that is less than or equal to 18.25.

According to a seventy-fifth aspect, the glass of the seventy-fourth aspect, wherein the glass has an Abbe number, ν_{d} that is less than or equal to 18.00.

According to a seventy-sixth aspect, the glass of the seventy-fifth aspect, wherein the glass has an Abbe number, ν_{d} that is less than or equal to 17.75.

According to a seventy-seventh aspect, the glass of any one of aspects 1-76, wherein the glass has a liquidus temperature, T_{liq} that is less than or equal to 1125° C.

According to a seventy-eighth aspect, the glass of the seventy-seventh aspect, wherein the glass has a liquidus temperature, T_{liq} that is less than or equal to 1100° C.

According to a seventy-ninth aspect, the glass of the seventy-eighth aspect, wherein the glass has a liquidus temperature, T_{liq} that is less than or equal to 1075° C.

According to a eightieth aspect, the glass of any one of aspects 1-79, wherein the glass has a glass transition temperature, T_{g} that is greater than or equal to 620° C.

According to an eighty-first aspect, the glass of the eightieth aspect, wherein the glass has a glass transition temperature, T_{g} that is greater than or equal to 640° C.

According to an eighty-second aspect, the glass of the eighty-first aspect, wherein the glass has a glass transition temperature, T_{g} that is greater than or equal to 650° C.

According to an eighty-third aspect, a method for manufacturing an optical element, the method comprising processing a glass, wherein the glass is the glass of any one of aspects 1-82.

According to an eighty-fourth aspect, an optical element comprising a glass, wherein the glass is the glass of any one of aspects 1-83.

Many variations and modifications may be made to the above-described embodiments of the disclosure without departing substantially from the spirit and various principles of the disclosure. All such modifications and variations are intended to be included herein within the scope of this disclosure and protected by the following claims.

To the extent not already described, the different features of the various aspects of the present disclosure may be used in combination with each other as desired. That a particular feature is not explicitly illustrated or described with respect to each aspect of the present disclosure is not meant to be construed that it cannot be, but it is done for the sake of brevity and conciseness of the description. Thus, the various features of the different aspects may be mixed and matched as desired to form new aspects, whether or not the new aspects are expressly disclosed.

1. A glass comprising a plurality of components, the glass having a composition of the components comprising
greater than or equal to 25.5 mol. % P₂O₅,
greater than or equal to 20.0 mol. % Nb₂P₅,
greater than or equal to 0.5 mol. % and less than or equal to 40.0 mol. % TiO₂,
greater than or equal to 0.1 mol. % and less than or equal to 8.0 mol. % Li₂O,
a sum of Na₂O+K₂O greater than or equal to 1.0 mol. % and less than or equal to 30.0 mol. %,
a sum of FeO+Fe₂O₃ greater than or equal to 0.000 mol. % and less than or equal to 0.020 mol. % and
optionally comprising one or more components selected from Al₂O₃, B₂O₃, BaO, Bi₂O₃, CaO, CdO, Cs₂O, GeO₂, La₂O₃, MgO, MoO₃, PbO, SiO₂, SrO, Ta₂O₅, TeO₂, WO₃, ZrO₂, Ga₂O₃ and ZnO,
wherein the composition of the components is
substantially free of V₂O₅,
and wherein the composition of the components satisfies the conditions:
$${P}_{2} {O}_{5} / \{ Ti {O}_{2} + N {b}_{2} {O}_{5} ) [ mol . \% ] \geq 0.3 and$$
$${K}_{2} O - N {a}_{2} O [ mol . \% ] \geq 0. ,$$
and wherein the glass satisfies the conditions:
Pₙ>1.9000 and
P_{d}<3.80,
where
Pₙ is a refractive index parameter, calculated from the glass composition in terms of mol. % of the components according to the Formula (I):
$${P}_{n} = 1.82063 - 0.0023121 * {AlO}_{3} - 0.003381 * {B}_{2} {O}_{3} - 0.00024425 * BaO + 0.0088252 * {Bi}_{2} {O}_{3} - 0.00051393 * CaO + 0.00083458 * CdO - 0.0021789 * {Cs}_{2} O - 0.0015444 * {GeO}_{2} - 0.0037344 * {K}_{2} O + 0.0022272 * {La}_{2} {O}_{3} - 0.0016171 * {Li}_{2} O - 0.0015687 * MgO + 0.0026917 * {MoO}_{3} - 0.0023954 * {Na}_{2} O + 0.007544 * {Nb}_{2} {O}_{5} - 0.0049543 * {P}_{2} {O}_{5} + 0.0033051 * PbO - 0.0029543 * {SiO}_{2} - 0.00038966 * SrO + 0.0069184 * {Ta}_{2} {O}_{5} + 0.0025768 * {TeO}_{2} + 0.0037599 * {TiO}_{2} + 0.0041441 * {V}_{2} {O}_{5} + 0.0032619 * {WO}_{3} + 0.0024821 * {ZrO}_{2} , \qquad ( I )$$
P_{d} is a density parameter, calculated from the glass composition in terms of mol. % of the components according to the Formula (II):
$${P}_{d} = 3.98457 - 0.015773 * {Al}_{2} {O}_{3} - 0.014501 * {B}_{2} {O}_{3} + 0.019328 * BaO + 0.060758 * {Bi}_{2} {O}_{3} - 0.0012685 * CaO + 0.023111 * CdO + 0.0053184 * {Cs}_{2} O + 0.011488 * {Ga}_{2} {O}_{3} - 0.0015416 * {GeO}_{2} - 0.013342 * {K}_{2} O + 0.058319 * {La}_{2} {O}_{3} - 0.007918 * {Li}_{2} O - 0.0024123 * MgO - 0.0024413 * {MoO}_{3} - 0.0082226 * {Na}_{2} O + 0.0084961 * {Nb}_{2} {O}_{5} - 0.020501 * {P}_{2} {O}_{5} + 0.038898 * PbO - 0.01272 * {SiO}_{2} + 0.013948 * SrO + 0.047924 * {Ta}_{2} {O}_{5} + 0.011248 * {YeO}_{2} - 0.0092491 * {V}_{2} {O}_{5} + 0.028913 * {WO}_{3} + 0.0074702 * ZnO + 0.0096721 * {ZrO}_{2} , \qquad ( II )$$
where an asterisk (*) means multiplication.

2. The glass of claim 1, wherein the composition of the components comprises
greater than or equal to 27.5 mol. % P₂O₅.

3. The glass of claim 1, wherein the composition of the components comprises
less than or equal to 32.0 mol. % P₂O₅.

4. The glass of claim 1, wherein the composition of the components comprises
greater than or equal to 13.0 mol. % TiO₂.

5. The glass of claim 1, wherein the composition of the components comprises
less than or equal to 36.0 mol. % TiO₂.

6. The glass of claim 1, wherein the composition of the components comprises
greater than or equal to 24.0 mol. % Nb₂O₅.

7. The glass of claim 1, wherein the composition of the components comprises less than or equal to 44.0 mol. % Nb₂O₅.

8. The glass of claim 1, wherein the composition of the components comprises
a sum of Li₂O+Na₂O+K₂O greater than or equal to 10.0 mol. %.

9. The glass of claim 1, wherein the composition of the components comprises two or more of Li₂O, Na₂O and K₂O.

10. The glass of claim 1, wherein the composition of the components satisfies the conditions:
K₂O−Na₂O [mol. %]≥0.50 and
Li₂O−Na₂O [mol. %]≥0.50.

11. The glass of claim 1, wherein the composition of the components comprises a sum of CaO+SrO+BaO greater than or equal to 3.0 mol. %.

12. The glass of claim 1, wherein the composition of the components comprises
greater than or equal to 25.5 mol. % and less than or equal to 29.0 mol. % P₂O₅,
greater than or equal to 20.0 mol. % and less than or equal to 35.0 mol. % Nb₂O₅,
greater than or equal to 10.0 mol. % and less than or equal to 40.0 mol. % TiO₂,
greater than or equal to 5.0 mol. % and less than or equal to 15.0 mol. % K₂O,
greater than or equal to 1.0 mol. % and less than or equal to 2.5 mol. % Li₂O,
greater than or equal to 0.0 mol. % and less than or equal to 10.0 mol. % BaO and
greater than or equal to 0.0 mol. % and less than or equal to 2.0 mol. % ZnO.

13. The glass of claim 1, wherein the composition of the components comprises
greater than or equal to 26.0 mol. % and less than or equal to 32.0 mol. % P₂O₅,
greater than or equal to 20.0 mol. % and less than or equal to 42.0 mol. % Nb₂O₅,
greater than or equal to 13.0 mol. % and less than or equal to 38.4 mol. % TiO₂,
greater than or equal to 2.00 mol. % and less than or equal to 15.0 mol. % K₂O,
greater than or equal to 0.00 mol. % and less than or equal to 11.0 mol. % BaO,
greater than or equal to 1.00 mol. % and less than or equal to 5.00 mol. % Li₂O and
greater than or equal to 0.0 mol. % and less than or equal to 2.0 mol. % Na₂O.

14. The glass of claim 1, wherein the composition of the components satisfies the condition:
$${P}_{2} {O}_{5} / \{ Ti {O}_{2} + N {b}_{2} {O}_{5} ) [ mol . \% ] \geq 0.45 .$$

15. The glass of claim 1, wherein the glass satisfies the condition:
Pₙ≥1.9300.

16. The glass of claim 1, wherein the glass satisfies the condition:
P_{d}<3.70.

17. The glass of claim 1, wherein the glass satisfies the condition:
P_{ref}>0.24,
where
P_{ref} is a refraction parameter, calculated from the glass composition in terms of mol. % of the components according to the Formula (IV):
$${P}_{ref} = 0.223637 + 0.0010703 * {Nb}_{2} {O}_{5} - 0.00041688 * {P}_{2} {O}_{5} + 0.00088482 * {TiO}_{2} + 0.000054956 * CaO - 0.00029243 * {K}_{2} O - 0.0008347 * BaO - 0.00023739 * {Na}_{2} O + 0.000082792 * {Li}_{2} O - 0.0012487 * {WO}_{3} - 0.00042393 * ZnO - 0.00059152 * SrO - 0.00018266 * MgO - 0.0014091 * {Bi}_{2} {O}_{3} - 0.0014895 * {Ta}_{2} {O}_{5} - 0.00021842 * {SiO}_{2} - 0.00024788 * {ZrO}_{2} - 0.00014801 * {B}_{2} {O}_{3} - 0.000060848 * {TeO}_{2} - 0.00085564 * PbO - 0.00042429 * {GeO}_{2} - 0.0015439 * {Tl}_{2} O - 0.0012936 * {Ag}_{2} O - 0.00089356 * {Cu}_{2} O - 0.00039278 * CuO + 0.00017895 * {As}_{2} {O}_{3} - 0.00011802 * {Sb}_{2} {O}_{3} . \qquad ( IV )$$
where an asterisk (*) means multiplication.

18. The glass of claim 1, wherein the glass satisfies the condition:
P_{ν}<18.50,
where
P_{ν} is a dispersion parameter, calculated from the glass composition in terms of mol. % of the components according to the Formula (III):
$${P}_{v} = exp ( 2.11 + 0.0438 * ( exp ( 3.2598 + 0.0072248 * {Al}_{2} {O}_{3} + 0.0055494 * {B}_{2} {O}_{3} + 0.0024164 * BaO - 0.00849 * {Bi}_{2} {O}_{3} + 0.0029812 * CaO + 0.0092768 * CdO + 0.0099824 * {Ga}_{2} {O}_{3} - 0.0038579 * {GeO}_{2} + 0.0028062 * {K}_{2} O + 0.0031951 * {Li}_{2} O + 0.0027011 * MgO + 0.007976 * {MoO}_{3} + 0.0028705 * {Na}_{2} O - 0.013374 * {Nb}_{2} {O}_{5} + 0.0072007 * {P}_{2} {O}_{5} - 0.0049796 * PbO + 0.0032241 * {SiO}_{2} + 0.0050024 * SrO - 0.002136 * {Ta}_{2} {O}_{5} - 0.0032329 * {TeO}_{2} - 0.009788 * {TiO}_{2} + 0.0074782 * {V}_{2} {O}_{5} - 0.00057095 * {WO}_{3} + 0.0032826 * ZnO + 0.009302 * {ZrO}_{2} ) ) ) , \qquad ( III )$$
where an asterisk (*) means multiplication.

19. The glass of claim 1, wherein the glass has a liquidus temperature, T_{liq} that is less than or equal to 1125° C.

20. The glass of claim 1, wherein the glass comprises less than or equal to 5.0 ppm Pt.
